(19) United States
(12) Patent Application Publication
(10) Pub. No.: US 2023/0330541 A1
(43) Pub. Date: Oct. 19, 2023

(54) METHOD AND APPARATUS FOR MAN-MACHINE INTERACTION BASED ON STORY SCENE, DEVICE AND MEDIUM

(71) Applicant: Tencent Technology (Shenzhen) Company Limited, Shenzhen (CN)

(72) Inventor: Guangze Dong, Shenzhen (CN)

(21) Appl. No.: 18/204,214

(22) Filed: May 31, 2023

Related U.S. Application Data
(63) Continuation of application No. PCT/CN2022/112406, filed on Aug. 15, 2022.

(30) Foreign Application Priority Data
Apr. 18, 2022 (CN) 202210406828.1

(51) Int. Cl. A63F 13/52; A63F 13/533; A63F 13/47; G06F 3/01; A63F 13/65; G06T 19/00; A63F 13/822

(52) U.S. Cl. CPC A63F 13/65; A63F 13/47; A63F 13/52; A63F 13/533; A63F 13/822; G06F 3/011; G06T 19/006; G06T 2200/24; G06T 2210/16

(57) ABSTRACT

This application discloses a method for human-machine interaction based on a story scene performed by a terminal with a camera. The method includes the following steps: acquiring a real video stream collected by the camera, displaying an AR video stream based on the real video stream, changing a display content of the AR video stream in response to an interaction operation, and completing a reasoning task corresponding to the story scene based on the changed display content. Since an AR background region is obtained by processing a background region in the real video stream and an AR character region is obtained by processing and replacing a foreground character region in the real video stream, a very immersive visual effect can be provided without requiring physical clothing, props and paper scripts, thus achieving a better visual experience while reducing the consumption of physical resources.

### CROSS-REFERENCE TO RELATED APPLICATIONS

This application is a continuation application of PCT Patent Application No. PCT/CN2022/112406, entitled “METHOD AND APPARATUS FOR MAN-MACHINE INTERACTION BASED ON STORY SCENE, DEVICE AND MEDIUM” filed on Aug. 15, 2022, which claims priority to Chinese Patent Application No. 202210406828.1, entitled “METHOD AND APPARATUS FOR MAN-MACHINE INTERACTION BASED ON STORY SCENE, DEVICE AND MEDIUM” filed on Apr. 18, 2022, all of which is incorporated herein by reference in its entirety.

### FIELD OF THE TECHNOLOGY

The embodiments of this application relate to the field of augmented reality (AR), in particular to a method and apparatus for human-machine interaction based on a story scene, a device and a medium.

### BACKGROUND OF THE DISCLOSURE

Script murder is a game in which a plurality of players respectively play a virtual character and each virtual character performs a reasoning process.

In the off-line script murder technology provided by related technologies, a projector is employed to project a projection picture on a wall of a script murder room. This projection picture is used for simulating a designated script murder scene, such as ancient wedding scene or spy warfare scene of the Republic of China. Players need to change their designated clothing and props, and use paper scripts to complete reasoning in the script murder room.

Although the off-line script murder mentioned above already has a good immersive experience, achieving this immersive experience requires a lot of physical resources, such as customized clothing, props and paper scripts for script murder scenes. When there are many off-line scripts for script murder, the consumption of specially customized physical resources is even more severe.

### SUMMARY

This application provides a method and apparatus for human-machine interaction based on story scene, a device and a medium. The technical solutions are described as follows:

According to one aspect, this application provides a method for human-machine interaction based on a story scene, the method being executed by a terminal with a camera and the method including:
acquiring a real video stream of a physical environment, the real video stream comprising a background region and a foreground character region of the physical environment, the foreground character region including an actual human character;
displaying an augmented reality (AR) video stream of a virtual environment based on the real video stream, the AR video stream comprising an AR background region and an AR character region of the virtual environment, the AR background region displaying a scene picture of the story scene based on the background region, the AR character region displaying the human character wearing an AR costume corresponding to a virtual character in the story scene based on the foreground character region;
changing a display content of the AR video stream in response to an interaction operation performed by the actual human character; and
completing a reasoning task corresponding to the story scene based on the changed display content.

According to another aspect, this application provides a method for human-machine interaction based on a story scene, the method including:
receiving a real video stream reported by a terminal;
performing image semantic recognition on a real video frame in the real video stream to obtain a background region and a foreground character region in the real video frame, the foreground character region corresponding to a real character;
processing a picture content in the background region to obtain an AR background region, and processing a picture content in the foreground character region to obtain an AR character region, the AR background region displaying a scene picture of the story scene, the AR character region displaying the real character wearing an AR costume, the AR costume corresponding to a virtual character in the story scene;
obtaining an AR video stream based on an AR video frame obtained by fusing the AR background region and the AR character region; and
transmitting the AR video stream to the terminal, so that the terminal completes a reasoning task corresponding to the story scene based on the AR video stream.

According to another aspect of this application, this application provides a terminal, the terminal including: a processor and a memory, the memory storing a computer program, the computer program being loaded and executed by the processor and causing the terminal to implement the method for human-machine interaction based on a story scene described above.

According to yet another aspect, this application provides a non-transitory computer-readable storage medium, storing a computer program, the computer program being loaded and executed by a processor of a terminal and causing the terminal to implement the method for human-machine interaction based on the story scene described above.

The technical solutions provided in the embodiments of this application have at least the following beneficial effects:

By replacing the background region in the real video stream with the AR background region corresponding to the reasoning task, and replacing the real character in the real video stream with the real character wearing the AR costume, a story scene of script murder or secret room escape is created by using the AR scene and the AR costume. thus providing a very immersive visual effect without requiring specially customized clothing, props and paper scripts. A better visual experience than related technologies is achieved under the situation that the consumption of specially customized physical resources is reduced.

### BRIEF DESCRIPTION OF THE DRAWINGS

FIG. 1 illustrates a schematic diagram of a real video stream collected by a user through a camera according to an exemplary embodiment of this application.

FIG. 2 illustrates a schematic diagram of an AR video stream displayed by an AR terminal of a user according to an exemplary embodiment of this application.

FIG. 3 illustrates a structural block diagram of a computer system according to an exemplary embodiment of this application.

FIG. 4 illustrates a flowchart of a method for human-machine interaction based on a story scene according to an exemplary embodiment of this application.

FIG. 5 illustrates a flowchart of a method for displaying an AR video stream based on a real video stream according to an exemplary embodiment of this application.

FIG. 6 illustrates a schematic diagram of not displaying AR glasses worn by a real character in an AR video stream according to an exemplary embodiment of this application.

FIG. 7 illustrates a flowchart of a method for human-machine interaction based on a story scene according to another exemplary embodiment of this application.

FIG. 8 illustrates a flowchart of a method for acquiring evidence collection information about a first virtual character based on a story scene according to an exemplary embodiment of this application.

FIG. 9 illustrates a flowchart of a method for acquiring evidence collection information about a first virtual character based on a story scene according to another exemplary embodiment of this application.

FIG. 10 illustrates a flowchart of a method for acquiring evidence collection information about a first virtual character based on a story scene according to another exemplary embodiment of this application.

FIG. 11 illustrates a flowchart of a method for human-machine interaction based on a story scene according to an exemplary embodiment of this application.

FIG. 12 illustrates a schematic diagram of dynamic video semantic segmentation according to an exemplary embodiment of this application.

FIG. 13 illustrates a schematic diagram of an FCN network structure according to an exemplary embodiment of this application.

FIG. 14 illustrates a schematic diagram of comparison of effects between FCN semantic segmentation results and a real sample according to an exemplary embodiment of this application.

FIG. 15 illustrates a schematic diagram of an AR picture displayed by an AR terminal of a user at an evidence collection stage according to an exemplary embodiment of this application.

FIG. 16 illustrates a game scene flowchart of a method for human-machine interaction based on a story scene according to an exemplary embodiment of this application.

FIG. 17 illustrates a structural block diagram of a computer system according to another exemplary embodiment of this application.

FIG. 18 illustrates a block diagram of an apparatus for human-machine interaction based on a story scene according to an exemplary embodiment of this application.

FIG. 19 illustrates a block diagram of an apparatus for human-machine interaction based on a story scene according to another exemplary embodiment of this application.

FIG. 20 illustrates a structural block diagram of a terminal according to an exemplary embodiment of this application.

FIG. 21 illustrates a structural block diagram of a server according to an exemplary embodiment of this application.

### DESCRIPTION OF EMBODIMENTS

First, terms involved in the embodiments of this application are briefly introduced.

Reasoning task: also known as a reasoning game, it is a task for one or more players to solve puzzles based on clues in a story scene. Traditional story scenes are mainly created through text on paper media. In recent years, in the popular off-line script murder games and secret room escape games, the story scenes are created by game venues built by merchants.

Script murder: it originates from a type of live-action role-playing game. The prototype is called Mystery of Murder. The game is centered around the script. The game progress is driven by the host (DM). Players complete their virtual character’s reasoning tasks through a plurality of rounds of evidence collection, speaking and reasoning, and reproduce the process of the event (crime technique). For example, in a certain script, a virtual character needs to decipher and reproduce a technique adopted by a murderer to murder someone in a secret room. Usually, the relationships between virtual characters in the script are also intricately related. Players need to immerse themselves in the virtual characters, carefully analyze based on the speeches and information about the players present, and ultimately vote their own identified murderer. After the game is over, the host reveals the truth and conducts a game replay. Some scripts also trigger one of a plurality of endings based on the players’ choice. These scripts with a plurality of endings are called “mechanism scripts”.

The entire game process is roughly as follows:
the host distributes scripts for different virtual characters to various players;
props are distributed in mechanism scripts for players to choose to trigger one of a plurality of endings;
players introduce themselves based on each virtual character;
under the guidance of the host, players gradually read the script, such as Act 1, Act 2, and so on;
evidence collection process and mechanism triggering process;
each player votes to select the murderer;
the host conducts a story plot replay - end of the game;
normally, the duration of a game is 4-5h.

Secret room escape: it is a type of live-action escape game. The earliest live-action room escape game originated in 2006 when a series of scenes were designed based on novel inspiration and reproduced to reality, providing all employees with adventure and puzzle solving, named “origin”. The main creativity of games mostly comes from scenes such as movies, TV dramas, books, and the Internet. During the game process, players usually use the first or third perspective to play the protagonist, and are confined to an almost completely closed or threatening environment (i.e., “secret room”). A single game has at least one secret room. Players need to discover and utilize props around them (such as paper props, mechanical props, electronic props and live-action props), reason and complete designated tasks (usually by solving specific puzzles), and ultimately achieve the goal of escaping from this region.

Story scene: each reasoning task corresponds to a story. The time, location, and environment of the story constitute the story scene of the reasoning task. For example, story scenes include spy scenes in the Republic of China, immortal cultivation scenes, Western cowboy scenes, and ancient tomb exploration scenes.

Story character: each reasoning task has at least one character. Different characters have different genders, images, personalities, story backgrounds, plot driving effects, and reasoning tasks. The virtual character may be a virtual character, a virtual animal, or a cartoon character.

Evidence collection: each reasoning task has at least one piece of evidence. Different pieces of evidence have different plot driving effects, which are obtained by players after corresponding operations on virtual props or other virtual characters.

Character information: different characters have different character information, such as name, age, gender, appearance, personality, growth background, social relationships, and schedule.

Public information: it is character information or evidence collection information that all virtual characters (or at least two virtual characters) in a reasoning task have a view permission.

Private information: it is character information that only one virtual character has a view permission in a reasoning task. For example, in pieces of information for a first virtual character, when there is information A that only a second virtual character has a view permission, then information A is the private information about the second virtual character.

This application provides an interaction solution for presenting a reasoning task of a story scene to a user based on AR. The reasoning task may be a game task with reasoning links, such as script murder or secret room escape. This application can present at least one of story scene, characters and character information to players by adopting AR technology.

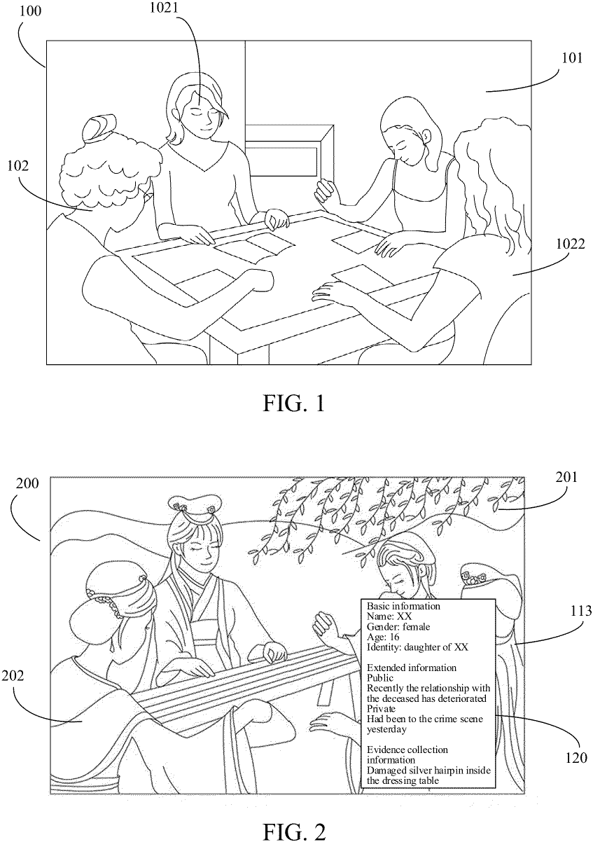

Taking script murder as an example, different players use different scripts and AR terminals. The AR terminals may be at least one of smart phones, tablets, e-book readers, laptops, desktop computers, and AR glasses. For example, user A, user B, user C and user D sit around a four-person table in a real scene, while user E stands next to the four-person table. After starting the script murder game, user A, user B, user C, user D and user E all each hold an AR terminal. One of the five users (any user, host user, or administrator user) selects one reasoning task from at least two candidate story scenes. Referring to FIG. 1, an AR terminal performs image semantic recognition on a real picture to obtain a background region 101 and a foreground character region 102. The foreground character region 102 includes a face region 1021 and a non-face region 1022. After face recognition is performed on the face region 1021, a character identity of a real character is obtained and bound to a virtual character that a player has selected. For example, user A is bound to a first virtual character, user B is bound to a second virtual character, user C is bound to a third virtual character, user D is bound to a fourth virtual character, and user E is bound to a fifth virtual character.

FIG. 1 illustrates a schematic diagram of a real picture 100 collected by a camera of user E. The real picture includes a background region 101 and a foreground character region 102. The foreground character region 102 corresponds to real characters user A, user B, user C, and user D. Exemplarily, the background region 101 is displayed as an interior of a room with low cabinet furnishings. The real character region includes a face region 1021 and a non-face region 1022. User A laterally faces the camera of user E. The face region 1021 displays the true appearance and frame glasses. The non-face region 1022 displays that the user A has a bun on the head and wears a sleeveless top. User B faces the camera of user E. The face region 1021 displays the true appearance. The non-face region 1022 displays that the user B has a splayed fringe and long hair to the shoulders, and wears a V-neck half-sleeved top. User C faces the camera of user E. The face region 1021 displays the true appearance. The non-face region 1022 displays that the user C has long hair to the shoulders and wears a tank top. User D oppositely faces the camera of user E. The non-face region 1021 displays that the hair is slightly curled and user D wears a short-sleeved top.

The AR terminal of each user will replace the background region 101 of the real picture 100 with the AR background region 201 based on a story scene material, and replace the non-face region 1022 of the real character based on the character material of the virtual character, thus replacing the foreground character region 102 with the AR character region 202 and replacing the real picture 100 with the AR picture 200. During at least one stage of the introduction stage and the evidence collection stage, the AR terminal will also display an AR information control 203 in the AR picture.

After the reasoning task starts, players can acquire character information corresponding to other virtual characters based on the AR picture 200. A method for acquiring character information includes: at least one of acquisition from the server, voice inputting, Optical Character Recognition (OCR) scanning and keyboard inputting. Exemplarily, during the public chatting, private chatting, or evidence collection stage, players can operate or interact with at least one of the virtual character, AR props and AR scene, and the corresponding virtual character will also perform the same action, thus acquiring evidence collection information about other virtual characters in the story scene, and displaying the information in the AR information control 203. Exemplary, based on the AR picture 200, user D acquires the following basic character information about the bound fourth virtual character from the server: character 4, female, 16 years old, daughter of imperial physician Yang; during the public chatting stage, user A, user B, user C and user E learn that character 4 has always had a good relationship with the victim, but their relationship has deteriorated recently; user E learns from private chatting with character 4 that character 4 had been to the crime scene yesterday; user E finds a damaged silver hairpin after evidence collection on a box of character 4.

FIG. 2 illustrates the AR picture 200 displayed on the AR terminal of user E, which includes the AR background region 201, the AR character region 202 and the AR information control 203. The AR background region 201 displays the story scene of the reasoning task. The AR character region 202 displays the real character wearing an AR costume 204. The AR costume 204 corresponds to the virtual character in the story scene, The AR information control 203 displays the evidence collection information about the virtual character (at least one of basic information, public information and private information). The AR information control 203 may be located on the periphery of the virtual character or at the position where the evidence collection information is acquired. Exemplarily, the AR background region 201 is displayed as a place under willow trees at the foot of a mountain outside the city. The AR character region 112 displays user A, user B, user C and user D wearing different ancient AR costumes, and user B is playing an AR virtual guqin. The information about the fourth virtual character bound to user D is displayed on the AR information control 120 on the periphery of the user D. The information acquired by user E during the private chatting stage is private information. User A, user B, user C and user D cannot view it. The information acquired by user E during the evidence collection stage is publicly available to other players. User A, user B, user C and user D can all view it.

User A, user B, user C, user D and user E, after public chatting, private chatting and evidence collection, vote to select the fourth virtual character bound to user D as the murderer. The voting result is correct, the reasoning task is completed, and the host may be selected for replay.

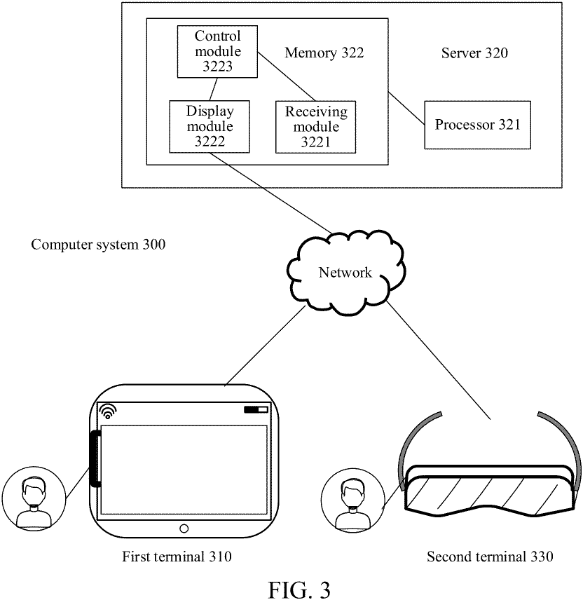

FIG. 3 illustrates a structural block diagram of a computer system according to an exemplary embodiment of this application. The computer system 300 includes a first terminal 310, a server 320, and a second terminal 330.

The first terminal 310 has a camera, and is installed with and runs an application program that supports AR interaction and a reasoning task. The first terminal 310 is an AR terminal used by a first user.

The terminal 310 is connected to the server 320 through a wireless or wired network.

The server 320 includes one server, a plurality of servers, a cloud computing platform, or a virtualized center. Exemplarily, the server 320 includes a processor 321 and a memory 322. The memory 322 includes a receiving module 3221, a display module 3222, and a control module 3223. The server 320 is configured to provide background services for the application program that supports AR interaction and a reasoning task. Optionally, the server 320 undertakes the main computing work, while the first terminal 310 and the second terminal 330 undertake the secondary computing work. Alternatively, the server 320 undertakes the secondary computing work, while the first terminal 310 and the second terminal 330 undertake the main computing work. Alternatively, the server 320, the first terminal 310, and the second terminal 330 adopt a distributed computing architecture for collaborative computing.

The second terminal 330 has a camera, and is installed with and runs an application program that supports AR interaction and a reasoning task. The second terminal 330 is an AR terminal used by a second user.

Optionally, the first virtual character and the second virtual character are in the same story scene. Optionally, the first virtual character and the second virtual character may belong to the same team or organization, be friends, or have temporary communication permissions.

Optionally, the application programs installed on the first terminal 310 and the second terminal 330 are the same, or the application program installed on the two terminals is the same type of application program on different control system platforms. The first terminal 310 may refer to one of a plurality of terminals in general. The second terminal 330 may refer to one of a plurality of terminals in general. This embodiment is described by taking the first terminal 310 and the second terminal 330 as an example. The device types of the first terminal 310 and the second terminal 330 are the same or different, including at least one of smart phones, tablets, e-book readers, laptops, desktop computers, and AR glasses. The following embodiments will be described by taking terminals including mobile phones and AR glasses as an example.

A person skilled in the art may be aware that the number of terminals or virtual characters mentioned above may be larger or smaller. For example, the number of the terminals or virtual characters may be only one, or the number of the terminals or virtual characters may be dozens or hundreds, or larger. The number of the terminals or virtual characters and the device types are not limited in the embodiments of this application.

It is to be understood that the information (including but not limited to user device information, user personal information, etc.), data (including but not limited to data used for analysis, stored data, displayed data, etc.), and signals involved in this application are all authorized by the users or fully authorized by all parties, and the collection, use, and processing of relevant data comply with relevant laws, regulations and standards of relevant countries and regions. For example, the real video stream involved in this application is acquired under full authorization. The terminal and server only cache the real video stream during program operation, and do not solidify, store, or reuse the relevant data of the real video stream.

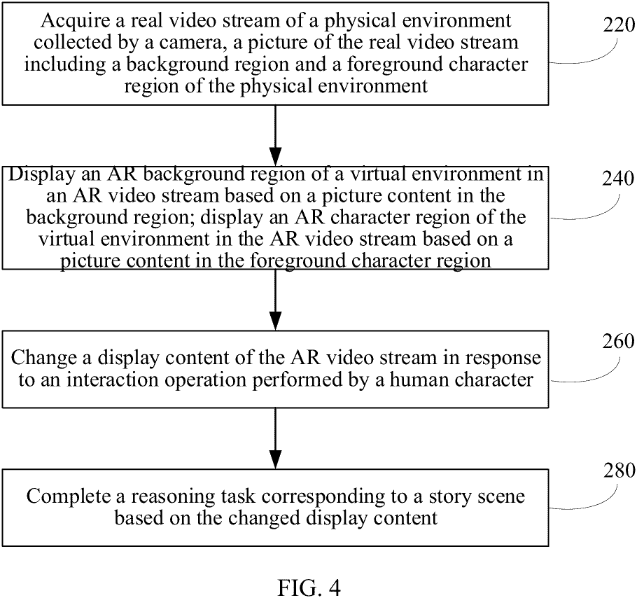

FIG. 4 illustrates a flowchart of a method for human-machine interaction based on a story scene according to an exemplary embodiment of this application. This embodiment will be described by taking the method being executed by a terminal illustrated in FIG. 3 as an example. The terminal is provided with a camera. The method includes the following steps:

In step 220, a real video stream of a physical environment collected by the camera is acquired. A video picture of the real video stream includes a background region and a foreground character region of the physical environment, the foreground character region including an actual human character.

An application program that supports AR interaction and a reasoning task is installed and run within the terminal. The reasoning task may be at least one of reasoning games such as script murder or secret room escape.

Taking script murder as an example, after receiving a user operation of starting the application program, the terminal displays at least two candidate story scenes. After receiving a user operation of selecting any story scene, the terminal displays at least two candidate virtual characters. After receiving a user operation of selecting any virtual character, the terminal binds the face data of the user to the selected virtual character.

Taking secret room escape as an example, after receiving a user operation of starting the application program, the terminal displays at least two candidate story scenes. After receiving a user operation of selecting any story scene, the terminal displays at least two candidate virtual characters. After receiving a user operation of selecting any virtual character, the terminal binds the face data of the user to the selected virtual character.

The terminal acquires a real video stream collected by the camera. The real video stream includes a plurality of real video frames, each of which constitutes a real video picture. The plurality of real video frames are arranged according to time sequence and displayed as continuous video pictures. In this embodiment, through image semantic recognition, the real video frames are segmented into a background region and a foreground character region. The plurality of real video frames are arranged according to time sequence and displayed as a real video stream. All or part of the real video frames of the real video stream include a background region and a foreground character region.

The background region refers to a scenery or setting region that sets off the real characters in the real video frames collected by the camera of the terminal. For example, the background region includes walls and furniture of a room.

The foreground character region refers to a real character region collected by the camera of the terminal. The real character region includes a face region and a non-face region. The face region refers to the face region of the real character in the real picture collected by the camera. The non-face region refers to the region other than the face region of the real character in the real picture collected by the camera, such as torso region and limb region.

Image semantic recognition: it refers to the technology in which computers process, analyze, and understand images to recognize two-dimensional regions where different semantic objects are located in the same video frame or image. For example, in the same real video frame, the background region, face region and non-face region are distinguished.

In step 240, an AR video stream of a virtual environment is displayed based on the real video stream.

The AR video stream includes a plurality of AR video frames, each of which constitutes an AR video picture. The plurality of AR video frames are arranged in time sequence and displayed as continuous AR video pictures. In some embodiments, there is a one-to-one corresponding relationship between the AR video frames in the AR video stream and the real video frames. In some embodiments, there is a one-to-one corresponding relationship between the AR video frames belonging to key frames in the AR video stream and the real video frames belonging to key frames in the real video stream.

In this embodiment, the AR video frame includes an AR background region and an AR character region of the virtual environment, the AR character region displays the real character wearing an AR costume, and the AR costume corresponds to a virtual character in the story scene. The AR background region is obtained by processing a picture content in the background region. The AR character region is obtained by processing a picture content in the foreground character region.

AR background region: it refers to a virtual background displayed during application program running. The AR background region is a three-dimensional environment formed for interaction between virtuality and reality by replacing the background region in the real video frame based on the scene material of the story scene, and fusing the virtual content and the real content in real time.

AR character region: it refers to a region of a real character wearing an AR costume displayed during application program running. The AR character region is a three-dimensional character region formed for interaction between virtuality and reality by replacing a non-face region of the real character based on the character material of the virtual character, and fusing the virtual content and a face region of the real character in real time.

There is at least one story scene in a reasoning task. There is at least one virtual character in a story scene. Each virtual character has at least one set of AR costumes. Optionally, a virtual character has different AR costumes in different story scenes, a virtual character has different AR costumes corresponding to different time periods in the same story scene, or a virtual character has different AR costumes corresponding to different locations in the same story scene.

In step 260, a display content of the AR video stream is changed in response to an interaction operation performed by the actual human character in the physical environment.

In some embodiments, a display content of the AR background region is changed in response to an item interaction operation with a virtual item in the AR background region.

Optionally, the item interaction operation includes at least one of an item touch operation, an item snatch operation, an item use operation, an item inspection operation, a gesture identification operation, an eyeball locking operation, and an eyeball sliding operation. The item touch operation refers to an operation of touching a virtual item. The item snatch operation refers to an operation of snatching a virtual item. The item use operation refers to an operation of using a virtual item. The item inspection operation refers to an operation of inspecting a virtual item.

Optionally, a method for changing the display content of the AR background region includes one of the following:

(1) Displaying a story clue in the AR background region in response to the item interaction operation with the virtual item in the AR background region;

In an embodiment, taking secret room escape as an example, after a player touches a vase in the AR background region, a way to escape from the secret room is displayed in a text form in the AR background region.

(2) Updating and displaying the virtual item in the AR background region in response to the item interaction operation with the virtual item in the AR background region.

In an embodiment, taking script murder as an example, player B holds assembly 1, and player A hands assembly 2 to player B, and the combined assembly 1 and assembly 2 are displayed.

(3) Updating the scene picture of the story scene in the AR background region in response to the item interaction operation with the virtual item in the AR background region.

In an embodiment, taking secret room escape as an example, in a secret room scene, after the player interacts with a virtual door in the AR background region, the secret room scene displayed in the AR background region is updated to an outdoor scene.

It is to be understood that the item interaction operations in the above different embodiments may be the same operation or different operations.

In some embodiments, character information about the real character is changed in response to a character interaction operation with the real character in the AR character region. Optionally, the character interaction operation includes at least one of a character touch operation, a character grip operation, a character conversation operation, a gesture identification operation, an eyeball locking operation and an eyeball sliding operation.

Optionally, the character information includes at least one of gender, age, identity, occupation, strong point, ability, skill, height, weight, and clothing.

Optionally, a method for changing the character information about the real character includes one of the following:

(1) Changing first character information about the virtual character to second character information in response to the character interaction operation with the virtual character in the AR character region.

In an embodiment, the character information includes occupation. After a conversation with user B, user A learns that the occupation of user B is “doctor” rather than “nurse”, so the occupation of user B is changed from “nurse” to “doctor”.

(2) Adding third character information about the virtual character in response to the character interaction operation with the virtual character in the AR character region.

In an embodiment, virtual character A asks virtual character B a question, virtual character B answers about the occupation of virtual character B, and a new occupation is added for virtual character B.

(3) Deleting fourth character information about the virtual character in response to the character interaction operation with the virtual character in the AR character region.

In an embodiment, virtual character A needs to fight against virtual character B, and in the event that virtual character A defeats virtual character B, the character information about virtual character B is deleted.

(4) Adding character relationship information between the virtual character and another virtual character in response to the character interaction operation with the virtual character in the AR character region.

In an embodiment, after a conversation between virtual character A and virtual character B, virtual character A learns that there is a brotherly relationship between virtual character B and virtual character C, and character relationship information between virtual character B and virtual character C is added.

It is to be understood that the character interaction operations in the above different embodiments may be the same operation or different operations.

In some embodiments, the scene picture of the story scene is changed in response to a scene switching operation on the story scene.

Optionally, the scene switching operation includes at least one of an item touch operation, an item snatch operation, a character touch operation, a character grip operation, a gesture identification operation, an eyeball locking operation, and an eyeball sliding operation.

Optionally, a first scene picture of the story scene is switched to a second scene picture in response to the scene switching operation on the story scene. The first scene picture and the second scene picture are different scene pictures.

In some embodiments, a display content related to a story plot in the AR video stream is changed in response to a story plot trigger operation on the story scene.

Optionally, the story plot trigger operation includes at least one of development of a story plot to a predetermined time point, an operation triggered by a virtual character to drive the development of the story plot, and an operation triggered by the host to drive the development of story plot.

Optionally, a method for changing a display content related to a story plot in the AR video stream in response to a story plot trigger operation on the story scene includes at least one of the following:

Optionally, the scene switching operation includes at least one of an item touch operation, an item snatch operation, a character touch operation, a character grip operation, a gesture identification operation, an eyeball locking operation, and an eyeball sliding operation.

(1) Changing the scene picture of the story scene in response to the story plot trigger operation on the story scene.

In some embodiments, after the virtual character gazes at a virtual item for 8 s, the story scene is switched from an ancient fairy tale scene to a modem urban scene.

(2) Adding a plot prop in the AR background region in response to the story plot trigger operation on the story scene.

In some embodiments, after the virtual character makes a jumping action, a newly added plot prop is displayed in the AR background region, which is used for driving the development of the story plot.

(3) Updating the character information about the virtual character in response to the story plot trigger operation on the story scene.

In some embodiments, after virtual character A tells virtual character B the occupation of virtual character A, the occupation of virtual character A is updated.

It is to be understood that the story plot trigger operations in the above different embodiments may be the same operation or different operations.

In step 280, a reasoning task corresponding to the story scene is completed based on the changed display content.

At least one of an information acquisition task, an evidence collection task and a puzzle reasoning task corresponding to the story scene is completed based on AR information displayed in the AR video stream. The AR information includes at least one of associated AR information displayed on the periphery of the AR character, associated AR information displayed on the periphery of the virtual prop, associated AR information displayed in the virtual environment, and associated AR information displayed on the non-player character (NPC).

The AR information includes at least one of text information, picture information, video information, audio information, animation information, and special effect information related to completing a reasoning task.

The information acquisition task is a task used for acquiring the character information about each virtual character.

Evidence collection task is a task used for collecting relevant evidence information in a reasoning task.

The puzzle reasoning task is a task that performs puzzle reasoning based on the acquired character information and/or relevant evidence information.

Taking the reasoning task being a script murder game as an example, this reasoning task includes at least one of an information acquisition task, an evidence collection task, and a puzzle reasoning task. Exemplarily, the information acquisition task includes at least one of an introduction stage, a public chatting stage, a private chatting stage, an evidence collection stage, and a case closure stage. The evidence collection task includes tan evidence collection stage. The puzzle reasoning task includes a case closure stage.

In an embodiment, the player acquires the story background information during the script introduction stage, the basic information about the virtual character during the public chatting stage and the private extended information about the virtual character during the private chatting stage, and performs an evidence collection operation on the virtual scene, the virtual prop or the NPC during the evidence collection stage to obtain evidence collection information. After analysis and voting, a reasoning result is obtained. The terminal displays or the host declares whether the result is correct, thus completing the reasoning task.

Taking the reasoning task being secret room escape as an example, this reasoning task includes at least one of an information acquisition task, an evidence collection task, and a puzzle reasoning task. Exemplarily, the information acquisition task includes an information search stage, the evidence collection task includes an evidence collection stage, and the puzzle reasoning task includes an escape stage. Information acquisition stage, evidence collection stage, and escape stage. During the information acquisition stage, the player may learn about the story background, reasoning task, or escape target of this secret room escape through the terminal, server, or staff.

In an embodiment, the player learns the story background and escape target of the secret room escape by reading the virtual information control displayed on the terminal. During the evidence collection stage, the player performs an evidence collection operation on the virtual scene, virtual prop or NPC to obtain a method for escaping from the secret room. After successfully escaping from the secret room, the reasoning task is completed.

Optionally, an interactive reasoning task corresponding to the story scene is completed based on AR information displayed in the AR video stream. The interactive reasoning task is a task of interacting with the scene picture of the story scene, or the interactive reasoning task is a task of interacting with the virtual character in the story scene.

In an embodiment, the player learns by reading the virtual information control displayed on the terminal that the method for escaping from the secret room is to complete the puzzle in the story scene. During the evidence collection stage, puzzle fragments are placed at designated positions to complete the puzzle, achieving the conditions for escaping from the secret room. After the puzzle is completed, the interactive reasoning task is completed.

In an embodiment, the player learns that the task of entering the next stage of script murder is to acquire a key held by the virtual character. After interacting with the virtual character during the evidence collection stage, the key held by the virtual character is acquired to proceed to the next stage of script murder. After the key is acquired, the interactive reasoning task is completed.

To sum up, in the method provided by this application, by replacing the background region in the real video stream with the AR background region corresponding to the reasoning task, and replacing the real character in the real video stream with the real character wearing the AR costume, a story scene of script murder or secret room escape is created by using the AR scene and the AR costume. thus providing a very immersive visual effect without requiring specially customized clothing, props and paper scripts. A better visual experience than related technologies is achieved under the situation that the consumption of specially customized physical resources is reduced.

In a possible embodiment, step 240 includes step 241, step 243, step 245, step 247, and step 249.

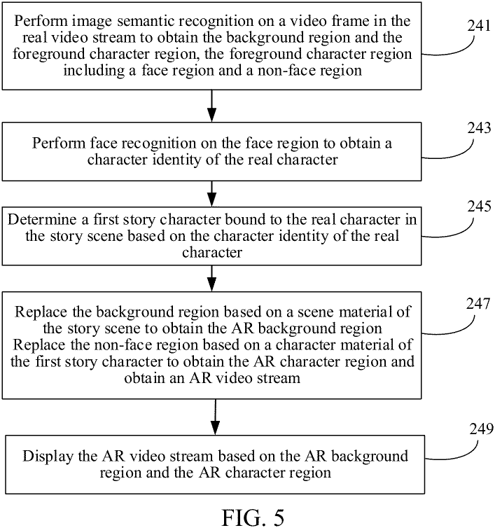

FIG. 5 illustrates a flowchart of a method for displaying an AR video stream based on a real video stream according to an exemplary embodiment of this application. This embodiment will be described by taking the method being executed by a terminal and/or server illustrated in FIG. 3 as an example. The method includes the following steps:

In step 241, image semantic recognition is performed on a video frame in the real video stream to obtain the background region and the foreground character region. The foreground character region includes a face region and a non-face region.

Exemplarily, user A, user B, user C, and user D sit around a four-person table in a real scene, while user E stands next to the four-person table. The cameras of the AR terminals used by each user collect different real video streams, which are uploaded to the server by each terminal. Each real video stream includes a plurality of real video frames. The server performs image semantic recognition on each real video frame to obtain the background region and the foreground character region in each real video frame.

Taking the real video stream uploaded by the terminal of user E as an example, the server can recognize the real video stream illustrated in FIG. 1 after analysis. The background region displays the interior of a room and a low cabinet. The foreground character region displays the real situations of faces, torsos and limbs of user A, user B, user C and user D.

In step 243, face recognition is performed on the face region to obtain a character identity of the real character.

The face region of each real character identified by the server corresponds to a set of face data. After identifying the face data, the server can determine the character identity of each real character.

Exemplarily, the face regions of user A, user B, user C, user D, and user E each correspond to a set of face data in the server. The camera of the AR terminal held by user E collects the face of any one of these four users, and the corresponding real character identity can be obtained.

In step 245, the first virtual character bound to the real character in the reasoning task is determined based on the character identity of the real character.

In an exemplary embodiment, before the reasoning task is initiated, user A, user B, user C, user D, and user E each use an AR terminal to select a virtual character, and the server binds the face data to the virtual character.

In an exemplary embodiment, before the reasoning task is initiated, one of the five users (any user, host user, or administrator user) selects or assigns a virtual character, and the server binds the face data of each user to the corresponding virtual character.

The server stores a binding relationship between the face data of each user and the virtual character. After the reasoning task is initiated and the character identity of the real character appearing in the real video frame is recognized, the first virtual character bound to the real character in the reasoning task is determined based on the binding relationship.

Optionally, for other character identities, the second virtual character, the third virtual character and so on bound to the real characters in the reasoning task are determined based on the binding relationship.

In step 247, the background region is replaced based on a scene material of the story scene to obtain the AR background region; the non-face region is replaced based on a character material of the first virtual character to obtain the AR character region and obtain an AR video stream;

the server determines a scene material of the story scene and a character material corresponding to each virtual character.

In an embodiment, the server respectively computes the contents in the background regions of the real video streams collected by user A, user B, user C, user D, and user E, and renders the scene material of the story scene to the background region to obtain an AR background region; the server computes the content in the non-face region of the foreground character region corresponding to each user, and renders the character material of the bound virtual character to the foreground character region to obtain a real character wearing an AR costume and obtain an AR character region. Exemplarily, the server renders the scene material of the story scene to the background regions of the real video streams collected by user A, user B, user C, user D, and user E. Taking user A as an example, the server renders the character material of the first virtual character bound to user A to the non-face region of user A collected by other users to obtain an AR video stream.

In an embodiment, the server computes the content in the background region of the real video stream collected by user E, and renders the scene material of the story scene to the background region to obtain an AR background region; the server 320 computes the content in the non-face region of the foreground character region corresponding to each user, and renders the character material of the bound virtual character to the foreground character region to obtain a real character wearing an AR costume and obtain an AR character region. Exemplarily, the server renders the scene material of the story scene to the real video stream collected by user E, and respectively renders the character material of the virtual character bound to each user to the non-face region collected by user E to obtain an AR video stream.

Optionally, the AR costume of the virtual character may be created locally and uploaded to the server, or self-defined locally and uploaded to the server.

Exemplarily, the AR costume of the virtual character may be created locally, for example, by modeling, and then the created AR costume is uploaded to the server. Alternatively, the AR costume is self-defined, for example, by adjusting the existing AR costume such as size, shape, spacing, or color, and then the self-defined AR costume is uploaded to the server.

In step 249, the AR video stream is displayed based on the AR background region and the AR character region.

In an embodiment, the AR video stream displayed by the terminal of each user is obtained from the real video stream collected by the camera of the terminal, uploaded to the server for processing, and then transmitted back to the terminal by the server. Taking user A as an example, the terminal used thereby uploads a real video stream, which is processed by the server to obtain an AR background region and an AR character region. The AR character region corresponds to user B, user C, user D and user E wearing AR costumes.

In an embodiment, the AR video stream displayed by the terminal of each user is obtained from the real video stream collected by the camera of any one terminal, uploaded to the server for processing, and then transmitted back to all terminals by the server. Exemplarily, the terminal used by user E uploads a real video stream, which is processed to obtain an AR background region and an AR character region. The AR character region corresponds to user A, user B, user C, user D and user E wearing AR costumes. Each terminal selectively displays the AR video stream from the corresponding perspective.

The above process may be executed a plurality of times by the computer system in a single reasoning task game. When the computing power of the terminal is strong, the above process may also be executed by the terminal without the cooperation of the server.

To sum up, in the method provided in this embodiment, a background region and a foreground character region in a real video stream are recognized through image semantic segmentation. The foreground character region includes a face region and a non-face region.

In some embodiments, the AR terminal is AR glasses. The real character displayed in the real video stream wears the AR glasses. Since the AR glasses may not match the story scene, for example, when the story scene is an ancient fairy tale scene, the AR glasses as modem consumer electronic devices do not match the ancient visual scene. Therefore, an embodiment of this application provides a method for not displaying AR glasses worn by a real character in an AR video stream in the method for human-machine interaction based on the story scene.

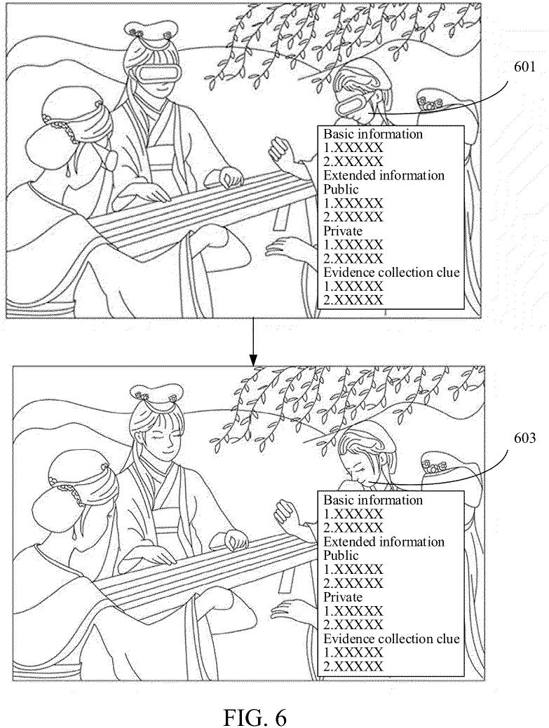

FIG. 6 illustrates a schematic diagram of a method for not displaying AR glasses worn by a real character in an AR video stream according to an embodiment of this application. Exemplarily, the server inputs sample face data of the real character collected and uploaded by the terminal and a first face picture 601 displayed in the AR video stream to a generative network for image reconstruction to obtain a second face picture 603 of the real character not wearing the AR terminal. In the second face region of the AR character region in the AR video stream, the second face picture 603 is displayed.

In an example, the generative network is a neural network with image reconstruction capabilities. The generative network includes a discriminator and a generator. In a training process, the discriminator and the generator are required to cooperate for training. In an application process, the generator is only required.

In the training process, a training set includes sets of sample data of different users. Each set of data includes a sample face picture (wearing the AR terminal) and sample face data (not wearing the AR terminal, such as a front face image of the user) of the same user. The computer device inputs the sample face picture and sample face data of the same user into the generator, which then reconstructs a predicted face picture. The sample face picture and the predicted face picture have the same face angle (possibly any angle), but the predicted face picture shows no AR terminal. Optionally, the sample face data is a front face image without the AR terminal, which is used for simulating the face of the user collected during the binding stage. The face angle of the sample face picture may be different from that of the sample face data.

The discriminator is configured to discriminate the predicted face picture or sample face picture, to recognize whether it is an image reconstructed by the generator or an original image. Based on the alternating training method of the generative network, the network parameters of the discriminator are fixed and the network parameters of the generator are updated. Alternatively, the network parameters of the generator are fixed and the network parameters of the discriminator are updated. Until the error converges or the number of training times reaches a preset number of times, the trained discriminator and generator are obtained.

During the application stage, the computer device inputs the sample face data of the real character collected and uploaded by the terminal and the first face picture displayed in the AR video stream to the generator for image reconstruction, to obtain a second face picture of the real character not wearing the AR terminal.

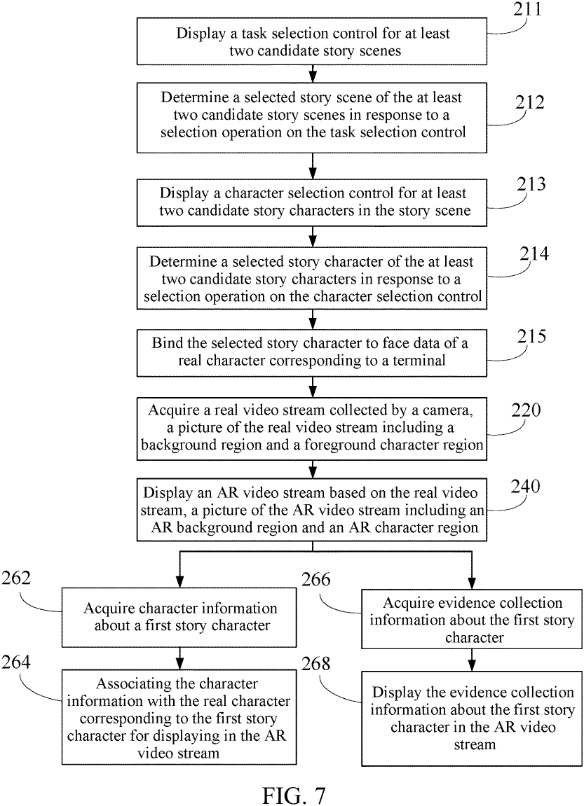

FIG. 7 illustrates a flowchart of a method for human-machine interaction based on a story scene according to another exemplary embodiment of this application. This embodiment will be described by taking the method being executed by the terminal and/or server illustrated in FIG. 3, and user A, user B, user C, user D and user E each holding a terminal for the same reasoning task illustrated in FIG. 1 as an example. The terminal is provided with a camera. The method includes the following steps:

In step 211, a task selection control for at least two candidate story scenes is displayed.

The task selection control is a control for selecting one story scene from the at least two candidate story scenes. The task selection control may be displayed in the form of a drop-down control, card control, or check control.

After receiving an initiation operation of initiating a reasoning task by the user, the terminal displays a task selection control for at least two candidate reasoning tasks. Each reasoning task corresponds to a story scene.

Taking the terminal being a mobile phone as an example, the user may perform a touch operation on an application program (including but not limited to clicking, double clicking, and sliding) to initiate a reasoning task. An application program interface displays at least two candidate reasoning tasks, such as spy tasks, Western cowboy tasks, ancient fantasy tasks and ancient tomb exploration tasks. The cover of each reasoning task provides a brief introduction to the story scene. The user can view it by sliding the interface on the mobile phone.

Taking the terminal being AR glasses as an example, the user may perform a touch operation (including but not limited to clicking, double clicking, pulling, dragging, and sliding) on a virtual selection control suspended in the air or lying on a table in front to initiate a reasoning task. The virtual selection control displays at least two candidate reasoning tasks, such as spy tasks, Western cowboy tasks, ancient fantasy tasks, and ancient tomb exploration tasks. The cover of each reasoning task has a brief introduction to the story scene. The user can view it through a sliding operation or browsing operation.

In step 212, a selected story scene of the at least two candidate story scenes is determined in response to a selection operation on the task selection control.

The selection operation is used for selecting the story scene displayed in the task selection control. The selection operation may be in the form of sliding and selecting in the drop-down control, dragging and selecting in the card control, or clicking and selecting in the check control.

Taking the terminal being a mobile phone as an example, user E clicks on the selection control of the reasoning task “Ancient Story 1” on the interface of the mobile phone held by user E. The interfaces of the mobile phones of user A, user B, user C, user D and user E all display the story scene of “Ancient Story 1”.

Taking the terminal being AR glasses as an example, the virtual selection control is laid flat on the table in front. All five users can slide to view various reasoning tasks. User E pulls the selection control of “Ancient Story 1” onto any user. The AR glasses of user A, user B, user C, user D and user E all display the story scene of the “Ancient Story One”.

In step 213, a character selection control for at least two candidate virtual characters in the story scene is displayed.

The character selection control is a control for selecting one virtual character from the at least two candidate virtual characters. The character selection control may be displayed in the form of a drop-down control, card control, or check control.

Taking the terminal being a mobile phone as an example, the interface of the mobile phone displays at least five candidate virtual characters, for example, character 1, character 2, character 4, character 3 and character 5.

Taking the terminal being AR glasses as an example, the virtual selection control is suspended in the air and displays at least five candidate virtual characters, for example, character 1, character 2, character 4, character 3 and character 5.

In step 214, a selected virtual character of the at least two candidate virtual characters is determined in response to a selection operation on the character selection control.

Taking the terminal being a mobile phone as an example, each user clicks on the virtual character selection control on the interface of the mobile phone held thereby to select a virtual character. For example, user A clicks on the selection control for character 1, user B clicks on the selection control for character 2, user C clicks on the selection control for character 3, user D clicks on the selection control for character 4, and user E clicks on the selection control for character 5 to complete virtual character selection.

Taking the terminal being AR glasses as an example, user A drags the virtual selection control for character 1 onto himself to select character 1, and user E respectively drags the selection controls for character 2, character 3, character 4 and character 5 onto user B, user C, user D and himself to complete virtual character selection.

In step 215, the selected virtual character is bound to face data of the real character corresponding to the terminal.

Taking the terminal being a mobile phone as an example, each user collects face data by using the camera of the terminal held thereby.

In an embodiment, the mobile phone uploads the collected face data to the server. The server binds the face data to the virtual character selected by the user. For example, the face data of user A is bound to character 1, the face data of user B is bound to character 2, the face data of user C is bound to character 3, the face data of user D is bound to character 4, and the face data of user E is bound to character 5.

In an embodiment, the mobile phone computes the collected face data. The mobile phone binds the face data to the virtual character selected by the user. For example, the face data of user A is bound to character 1, the face data of user B is bound to character 2, the face data of user C is bound to character 3, the face data of user D is bound to character 4, and the face data of user E is bound to character 5.

Taking the terminal being AR glasses as an example and taking user E as an example, the AR glasses held by user E collect the face data of user A, user B, user C and user D.

In an embodiment, the AR glasses of user E upload the face data of these four users to the server. The server binds the face data of user A, user B, user C and user D respectively to character 1, character 2, character 3 and character 4 selected thereby. The AR glasses held by user A collect the face data of user E and then upload it to the server. The server binds the face data of user E to character 5 selected thereby.

In an embodiment, the AR glasses of user E computes the face data of these four users, and binds the face data of user A, user B, user C and user D respectively to character 1, character 2, character 3 and character 4 selected thereby. The AR glasses held by user A collect the face data of user E and then perform computing to obtain the face data of user E. The face data is bound to character 5 selected thereby.

In some embodiments, when a person other than the five users suddenly enters the room during the reasoning task, the server will bind the face data of this person collected by the camera of the terminal held by any user to the NPC in the story scene that has no driving effect on the plot. Exemplarily, a cleaner suddenly enters the room, the camera of user E collects the face data of the cleaner and uploads it to the server through the AR terminal, the server binds the face data to the NPC floor cleaning maid in the story scene, and the terminals of user A, user B, user C, user D and user E display that the cleaner is a floor cleaning maid wearing an ancient AR costume.

In step 220, a real video stream collected by the camera is acquired. A picture of the real video stream includes a background region and a foreground character region.

Taking user E as an example, the camera of the AR terminal collects a real video stream as illustrated in FIG. 1.

In an embodiment, the real video stream is uploaded from the terminal to the server. The server recognizes a background region and a foreground character region through image semantic recognition. The background region is a room with low cabinet furnishings. The foreground character region is user A, user B, user C and user D with true appearances displayed.

In an embodiment, after the camera collects a real video stream, the terminal performs image semantic recognition on the real video stream to recognize a background region and a foreground character region. The background region is a room with low cabinet furnishings. The foreground character region is user A, user B, user C and user D with true appearances displayed.

In step 240, an AR video stream is displayed based on the real video stream. A picture of the AR video stream includes an AR background region and an AR character region.

In an embodiment, the terminal of each user replaces the scene material and character material of the story scene into the real video stream collected by the camera. Optionally, the scene material or character material may be acquired by the terminal from the server, or the scene material or character material may be read from the terminal.

In an embodiment, the server replaces the scene material and character material of the story scene into the real video stream uploaded by user E, and then transmits the AR video stream obtained after replacement back to the terminals of the five users. Each terminal displays the corresponding AR video stream according to the respective perspective.

Optionally, the scene material is a three-dimensional scene formed by fusing a virtual content and a real content in real time based on the time and space arrangement of the real environment where the user is located. Alternatively, the scene material is a three-dimensional scene that is inconsistent with the time and space of the real environment where the user is located.

For example, the terminals held by user A, user B, user C, user D and user E may all acquire the scene material (such as foot of a mountain outside a city, Fuju Restaurant, and bedrooms of character 1, character 2, character 4, character 3 and character 5) and the character material (such as clothing and dress-up of character 1, character 2, character 4, character 3 and character 5) of “Ancient Story 1” from the server. Then, the scene material and the character material are replaced into the collected real video stream by the respective terminal. During the public chatting stage, all five users are located at the foot of the mountain outside the city. AR materials such as mountains, water, trees, sky and terrain in this scene are inconsistent with the three-dimensional structure of the room where the user is actually located, thus creating a broader outdoor visual effect. During the evidence collection stage, the bedrooms of the five virtual characters are arranged according to the actual room where the users are located. For example, Virtual walls are rendered to real walls, virtual beds are rendered to real corners, virtual tables and cabinets are rendered to real tables and cabinets, etc.

In the process of completing the reasoning task corresponding to the story scene based on the AR video stream, the reasoning task includes: at least one of an information acquisition task, an evidence collection task, and a puzzle reasoning task.

### For the Information Acquisition Task

In step 262, character information about the first virtual character is acquired.

The terminal may acquire the character information about the first virtual character through at least one of acquisition from the sever, voice inputting, OCR scanning, and keyboard inputting.

In an embodiment, the server stores the character information about all virtual characters. After the reasoning task enters a specific stage, the terminal can automatically acquire the corresponding character information from the server.

In an embodiment, after acquiring the character information about the current or other virtual characters, the user may input the character information into the terminal through voice. For example, when the user holds a paper script, the user may read the text content on the script and input the character information about the virtual character in the script into the terminal through voice.

In an embodiment, the user may use OCR to scan pictures, paper scripts, virtual paper props and the like containing virtual character information to acquire corresponding information.

In an embodiment, the user may input the character information about the virtual character into the terminal through a keyboard. The keyboard may be a keyboard displayed on a terminal interface with a camera such as a smart phone, tablet, portable computer or e-book reader, or a virtual keyboard displayed by AR glasses.

Exemplarily, during the public chatting stage, user E reads out the identity information and interpersonal relationship introduction of character 5 acquired from the server. User A and user C input the voice of user E to acquire the identity information and interpersonal relationship introduction of character 5. User B performs OCR scanning on the information picture on the table top to acquire the identity information and interpersonal relationship introduction of character 5, User D inputs the identity information and interpersonal relationship profile of character 5 through a mobile phone keyboard or AR virtual keyboard.

Exemplarily, user E and user D have a private chat and learn that character 4 bound to user D had been to the crime scene in Fuju Restaurant the day before the incident. The information is input into the AR terminal through a keyboard.

In step 264, first AR information is displayed in the AR video stream. The first AR information is used for associating the character information with the real character corresponding to the first virtual character for displaying.

In an embodiment, the AR terminal of user B displays a first AR information control located on the periphery of user A, and the character information about character 1 acquired by user B is displayed on the first AR information control. The public information about character 1 acquired by user B during the public chatting stage may also be viewed by user C, user D and user E on the first AR information control located on the periphery of user A and displayed on their own terminals. The public information about character 1 acquired by user B during the public chatting stage is not displayed on the first AR information control located on the periphery of user A and displayed on the terminals held by user C, user D and user E.

Exemplarily, the first AR information control about character 5 is displayed on the periphery of user E, and the information related to character 5 acquired by other users during the reasoning task is displayed on the first AR information control.

Exemplarily, the information acquired by user E during the private chatting that character 4 had been to the crime scene the day before the incident is displayed on the first AR information control located on the periphery of user D. However, as this information is private to user E, user A, user B, user C and user D cannot see it on the first AR information control located on the periphery of user D.

Exemplarily, the acquired character information may be sorted according to the user’s acquisition time or the time line in the reasoning task, making it easy for the user to view, analyze, and reason.

Exemplarily, the information in this information control may be displayed in at least one of the forms of text description, picture description, voice description and video playback.

To sum up, in the method provided in this embodiment, by displaying the reasoning tasks of at least two story scenes and the virtual characters of at least two story scenes, and receiving the selection operations of the users, a richer game experience can be provided. By binding the virtual characters to the face data of the users, replacing the real video stream with the AR video stream, a more immersive visual experience and sense of immersion can be provided. By receiving the character information about the first virtual character and the operation of acquiring the evidence collection information, and displaying the character information and evidence collection information in the AR video stream, the cost of information recording is reduced, the fun of information viewing is enhanced, and it is also convenient for the users to bind the virtual characters to the information.

### For the Evidence Collection Task

In step 266, evidence collection information about the first virtual character is acquired.

In an embodiment, the user may perform an evidence collection operation on the virtual scene in the story scene, including but not limited to touching, clicking, zooming-in, zooming-out and splicing, to acquire evidence collection information in the virtual scene.

In an embodiment, the user may perform an evidence collection operation on the virtual props in the story scene, including but not limited to opening, closing, smashing, splicing, position adjusting and tapping, to acquire evidence collection information on the virtual props.

In an embodiment, the user may perform an evidence collection operation on the NPC in the story scene, including but not limited to attacking, avoiding, touching, hugging, and communicating, to acquire the evidence collection information on the NPC.

In step 268, second AR information is displayed in the AR video stream. The second AR information is used for displaying the evidence collection information about the first virtual character.

In an embodiment, the evidence collection information acquired by user A in the virtual scene is displayed on the second AR information control in the virtual scene. If user A selects to make it public, all virtual characters have the viewing permission. If user A selects to make it private, other virtual characters cannot view it.

In an embodiment, the evidence collection information acquired by user B on a virtual prop is displayed on the second AR information control on the periphery of the virtual prop. If user B selects to make it public, all virtual characters have the viewing permission. If user B selects to make it private, other virtual characters cannot view it.

In an embodiment, the evidence collection information about a certain virtual character acquired by user C during the evidence collection stage is displayed on the second AR information control on the periphery of the user. If user C selects to make it public, all virtual characters have the viewing permission. If user C selects to make it private, other virtual characters cannot view it.

The method for acquiring the evidence collection information about the first virtual character based on a story scene may be implemented under the following three situations:

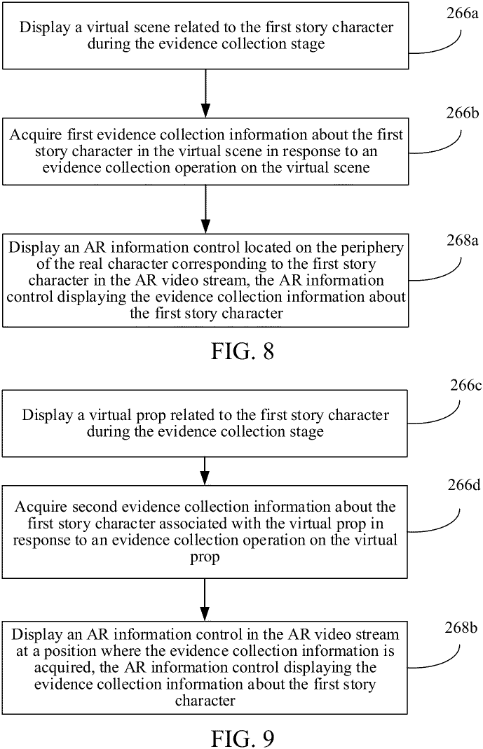

Under a first situation (evidence collection based on a virtual scene), referring to FIG. 8:

In step 266a, a virtual scene related to the first virtual character is displayed during the evidence collection stage.

Exemplarily, after entering the evidence collection stage, the user may freely select the virtual scene for evidence collection. Optionally, there is no NPC in the virtual scene, or there is an NPC in the virtual scene.

For example, user E wants to perform evidence collection on the bedroom of character 4 and selects the bedroom of character 4 in the AR virtual scene displayed on the AR terminal. This selection may be achieved by clicking, sliding, pulling and fixing the visual line for more than 5 s.

In step 266b, first evidence collection information about the first virtual character in the virtual scene is acquired in response to an evidence collection operation on the virtual scene.

Exemplarily, user C performs evidence collection in the bedroom of character 4 and finds that the furniture is messy, as if it has been messed up due to searching for something. Three seconds after the terminal of user C aims at the messy furniture, the terminal recognizes and acquires the evidence collection information.

In step 268a, a second AR information control located on the periphery of the real character corresponding to the first virtual character is displayed in the AR video stream. The second AR information control displays the evidence collection information about the first virtual character.

In an embodiment, user C finds that the furniture in the bedroom of character 4 bound to user D is messy due to searching for something, and this evidence collection information is displayed on the AR information control on the periphery of user D.

The evidence collection information may be selected to be public or private. If it is selected to be public, other virtual characters in the story scene can also view it. If it is selected to be private, other virtual characters in the story scene cannot view it.

Under a first situation (evidence collection based on a virtual prop), referring to FIG. 9:

In step 266c, a virtual prop related to the first virtual character is displayed during the evidence collection stage.

Exemplarily, after entering the evidence collection stage, the AR terminal of the user may display a virtual prop related to a certain virtual character. Optionally, the virtual prop exists in a specific virtual scene, or it does not need to exist in a specific scene.

For example, if user E selects to perform evidence collection on the guqin of character 2 bound to user B, user E may select to view the guqin in any scene of the reasoning task “Ancient Story 1”.

For example, if user E selects to perform evidence collection on the dressing table of character 4 bound to user D, the terminal of user E will only display the dressing table after user E enters the bedroom of character 4.

In step 266d, second evidence collection information about the first virtual character associated with the virtual prop is acquired in response to an evidence collection operation on the virtual prop.

Exemplarily, user E observes the AR virtual guqin of character 2 bound to user B and finds a blood stain on the AR virtual guqin. After user E places his finger on the blood stain for 3 s, the AR terminal recognizes and acquires the evidence collection information about character 2.

Exemplarily, user E performs evidence collection in the AR virtual bedroom of character 4 bound to user D. After using the AR terminal to aim at the dressing table of character 4 for 5 s, the dressing table opens and a damaged silver hairpin is found in the dressing table. After using the AR terminal to aim at the damaged silver hairpin for 3 s, the AR terminal recognizes and acquires the evidence collection information about character 4.

In step 268b, a second AR information control is displayed in the AR video stream at a position where the evidence collection information is acquired. The second AR information control displays the evidence collection information about the first virtual character.

In an embodiment, user E finds a blood stain on the guqin of character 2 bound to user B, and this evidence collection information is displayed on the AR information control on the periphery of the guqin.

In an embodiment, user B finds a damaged silver hairpin in the dressing table in the bedroom of character 4, and this evidence collection information is displayed on the AR information control on the periphery of the dressing table.

The evidence collection information may be selected to be public or private. If it is selected to be public, other virtual characters in the story scene can also view it. If it is selected to be private, other virtual characters in the story scene cannot view it.

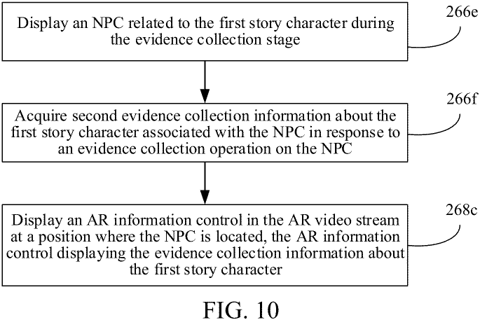

Under a third situation (evidence collection based on an NPC), referring to FIG. 10:

In step 266e, an NPC related to the first virtual character is displayed during the evidence collection stage.

Exemplarily, after entering the evidence collection stage, the AR terminal of the user may display an NPC related to a certain virtual character. The NPC exists in a specific virtual scene, or the NPC does not need to exist in a specific virtual scene.

For example, user B wants to perform evidence collection on a maid in the bedroom of character 3 and selects the bedroom of character 3 in the AR virtual scene displayed on the AR terminal. This selection may be achieved by clicking, sliding, pulling and fixing the visual line for more than 5 s. The maid is displayed in the bedroom.

In step 266f, third evidence collection information about the first virtual character associated with an NPC virtual character is acquired in response to an interaction operation on the NPC virtual character.

Exemplarily, user B performs evidence collection on the maid in the bedroom of character 3 bound to user C. After pulling the maid’s sleeve, it is found that there are bruises. The terminal of user B acquires the evidence collection information that “character 3 often beats up the maid” from the server.

In step 268c, a second AR information control is displayed in the AR video stream at a position where the NPC is located. The second AR information control displays the evidence collection information about the first virtual character.

In an embodiment, user B finds scars on the maid of character 3 bound to user C, and this evidence collection information is displayed on the AR information control on the periphery of user C.

The evidence collection information may be selected to be public or private. If it is selected to be public, other virtual characters in the story scene can also view it. If it is selected to be private, other virtual characters in the story scene cannot view it.

### For the Puzzle Reasoning Task

In some embodiments, the user may use the terminal to complete a puzzle reasoning task based on the AR video stream. The puzzle reasoning task based on the AR video stream provided in this embodiment can be divided into the following two situations:

First situation based on time line control:

In step a, a time line control corresponding to the story scene is displayed. The time line control displays at least one of the character information and evidence collection information about the first virtual character according to time sequence.

The time line control is a control that can display the character information or evidence collection information according to time sequence. The time sequence may be real time sequence, or time sequence of the story scene.

Exemplarily, user A sorts the acquired information about character 2 according to time sequence in the story scene on the time line control displayed on the AR terminal.

In step b, reasoning is performed on the reasoning task corresponding to the story scene in a time dimension in response to a reasoning operation on the time line control.

The reasoning operation based on the time line control includes but is not limited to finding or reasoning suspicious points on the time line in the acquired character information or evidence collection information.

Exemplarily, user A finds evidence that the alibi of character 2 at the time of the crime is invalid in the information displayed according to time sequence in the story scene.

Second situation based on virtual map control:

In step c, a virtual map control corresponding to the story scene is displayed. The virtual map control displays at least one of the character information and evidence collection information about the first virtual character according to geographical location.

The virtual map control is a control that can display the character information or evidence collection information according to geographical location. The virtual map may be the real geographical location, or geographical location of the story scene.

Exemplarily, user A displays the acquired information about character 3 according to the geographical location in the story scene on the virtual map control displayed on the AR terminal.

In step d, reasoning is performed on the reasoning task corresponding to the story scene in a space dimension in response to a reasoning operation on the virtual map control.

The reasoning operation based on the virtual map control includes but is not limited to finding or reasoning suspicious points in the geographical location in the acquired character information or evidence collection information.

Exemplarily, user A finds evidence that character 3 had been to the crime scene in the information about character 3 displayed according to the geographical location in the story scene.

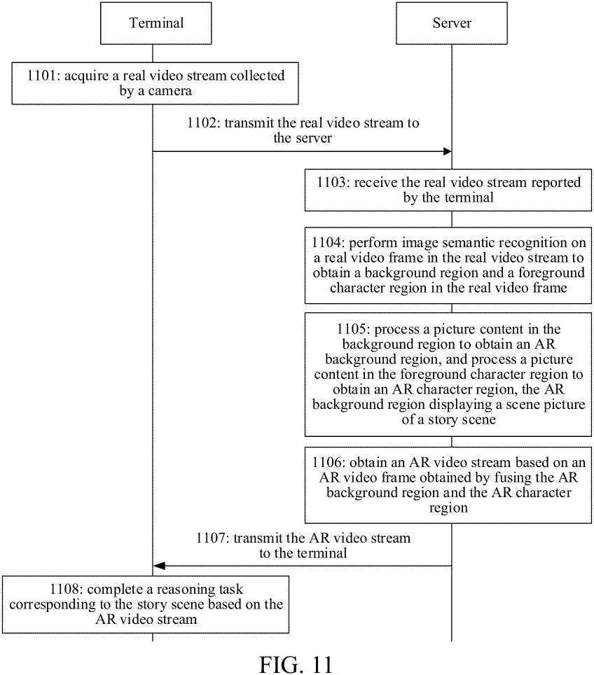

FIG. 11 illustrates a flowchart of a method for human-machine interaction based on a story scene according to an exemplary embodiment of this application. The method may be executed by a terminal and a server. The method includes the following steps:

In step 1101, a terminal acquires a real video stream collected by a camera.

The terminal is provided with the camera. After a reasoning task is initiated, the camera on the terminal collects the environment in front to obtain a real video stream. The real video stream includes a plurality of real video frames arranged in sequence (referred to as video frames).

Optionally, the real video stream may be a video stream that has been encoded and compressed.

In step 1102, the terminal transmits the real video stream to a server.

The terminal transmits the real video stream to a server through a wireless or wired network.

In step 1103, the server receives the real video stream reported by the terminal.

In step 1104, the server performs image semantic recognition on a real video frame in the real video stream to obtain a background region and a foreground character region in the real video frame. The foreground character region corresponds to a real character.

An image semantic segmentation model is stored in the server. The server inputs a semantic segmentation result of a previous video frame in the real video stream and a current video frame into the image semantic segmentation model to obtain a semantic segmentation result of the current video frame. The semantic segmentation result includes a background region and a foreground character region.

Optionally, when processing a first video frame in the real video stream, the server inputs a reference segmentation result and the first video frame into the image semantic segmentation model to obtain a semantic segmentation result of the first video frame. The reference segmentation result may be a preset segmentation result, or a rough segmentation result after semantic segmentation of the first video frame using other models, or a blank segmentation result, which is not limited in this application.

Optionally, when processing other video frames other than the first video frame in the real video stream, the server inputs a segmentation result of a (i-1)^{th} video frame and an i^{th} video frame into the image semantic segmentation model to obtain a semantic segmentation result of the i^{th} video frame.

In an example, the image semantic segmentation model can output two semantic classifications, including a background region and a foreground character region. In an example, the image semantic segmentation model can output three semantic classifications, including a background region, and a face region and a non-face region in a foreground character region. In another example, the image semantic segmentation model can output a plurality of semantic classifications, including a plurality of sub-regions in a background region and a foreground character region. The plurality of sub-regions include at least two of a face region, a torso region, a limb region, a palm region, a finger region, and a backbone key point. The semantic segmentation ability of the image semantic segmentation model is not limited in this application.

In step 1105, the server processes a picture content in the background region to obtain an AR background region, and processes a picture content in the foreground character region to obtain an AR character region. The AR background region displays a scene picture of the story scene. The AR character region displays the real character wearing an AR costume. The AR costume corresponds to a virtual character in the story scene.

There is at least one story scene in a reasoning task. There is at least one virtual character in a story scene. Each story scene has a corresponding scene material. Each virtual character has a corresponding character material.

The scene material of the story scene includes but is not limited to at least one of a natural environment material, a cultural architecture material, an outdoor decoration material, an indoor decoration material, a furniture material, and an environmental prop material.

The character material of the virtual character includes but is not limited to a jewelry material, a face makeup material, a top material, a pants material, a dress material, a shoes materials, a hand-held prop material, a transportation material or riding material, and so on. For example, the character material of a virtual character ancient swordsman includes a jade hairpin material, sect clothing, a sword material, and so on. For another example, the character material of a virtual character of a Western cowboy story includes a cowboy hat material, a shirt material, a jeans material, a horse material, a pistol material, and so on.

After recognizing the background region and the foreground character region in the real video frame, the server replaces or fuses the background region based on the scene material of the story scene to obtain an AR background region; and replaces or fuses the non-face region based on a character material of the first virtual character to obtain the AR character region.

In an example, the server directly replaces the background region with the scene material without considering any physical information in the background region to obtain an AR background region. For example, it replaces an office background in the real scene with the background of a sect mountain. In another example, while considering the three-dimensional structural information in the background region and preserving the original main structure in the background region, the server uses a surface map in the scene material to re-render the environment in the background region to obtain a personalized AR background region based on the original main structure. For example, it re-renders a room in the real scene to obtain a living room of a noblewoman.

In an example, the server replaces clothing in the non-face region based on the character material of the first virtual character to obtain the AR character region. Alternatively, the server adds a virtual jewelry or prop to the non-face region based on the character material of the first virtual character to obtain the AR character region.

Optionally, the virtual characters bound to each real character may be different.

In some embodiments, the same virtual character has different AR costumes at different time periods in the same story scene. Alternatively, the same virtual character has different AR costumes at different places in the same story scene. Alternatively, the same virtual character has different AR costumes in different story scenes. Alternatively, the same virtual character has different AR costumes at different time periods in different story scenes. Alternatively, the same virtual character has different AR costumes at different places in different story scenes.

In step 1106, the server obtains an AR video stream based on an AR video frame obtained by fusing the AR background region and the AR character region.

Optionally, there is a one-to-one corresponding relationship between the AR video frames and the real video frames. The AR background region and the AR character region obtained after processing the same real video frame are fused to obtain the AR video frame corresponding to the real video frame.

The server stitches various AR video frames according to time sequence to obtain an AR video stream. Optionally, the server also encodes and compresses the AR video stream to reduce network bandwidth consumption during data transmission.

In step 1107, the server transmits the AR video stream to the terminal.

The server transmits the AR video stream to the terminal through the wireless or wired network.

In step 1108, the terminal completes the reasoning task corresponding to the story scene based on the AR video stream.

To sum up, in the method provided in this embodiment, by using the server located in the cloud to undertake the computing task of image semantic segmentation, the local computing resource consumption of the terminal can be significantly reduced, thus achieving a smoother AR experience.

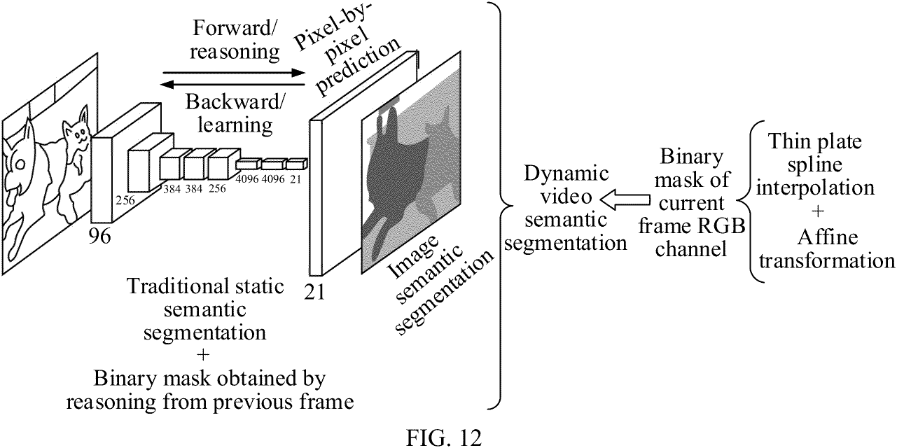

In addition, referring to FIG. 12, this embodiment implements dynamic video semantic segmentation on the basis of traditional static semantic segmentation. In the traditional static semantic segmentation, the image to be classified is input into the image semantic segmentation model for semantic segmentation to obtain a semantic segmentation result. In this embodiment, the semantic segmentation result of the previous video frame and the current video frame are input into the image semantic segmentation model for semantic segmentation to obtain the semantic segmentation result of the current video frame. Since the semantic segmentation result of the previous video frame is introduced as reference information in the image semantic segmentation task of the current video frame, utilizing the high correlation between the previous video frame and the current video frame in the time domain can accelerate the computing speed of the image semantic segmentation task, shorten the time spent in the image semantic segmentation of the current video frame, and improve the accuracy of image semantic segmentation of the current video frame.

In some embodiments, the image semantic segmentation model is obtained by training based on a basic sample library. The basic sample library includes a semantic segmentation label of a previous sample video frame, a current sample video frame, and a semantic segmentation label of the current sample video frame. The previous sample video frame is a video frame before the current sample video frame in sample video frames. If the current sample video frame is the first frame, the previous video frame may be replaced by a current sample video frame obtained after affine transformation or Thin Plate Spline (TPS) interpolation. The semantic segmentation label of the previous sample video frame and the semantic segmentation label of the current sample video frame may be manually labeled cutout sample masks, or the cutout sample masks after semantic segmentation using the traditional static image semantic segmentation model.

Affine transformation: it is an image transformation method that describes a linear transformation of two-dimensional coordinate points. Affine transformation can perform a linear transformation and then a translation on two-dimensional coordinate points. In the embodiment of this application, affine transformation can simulate the movement of real characters.

TPS interpolation: it is a two-dimensional interpolation method used for offsetting control points on an image to achieve specific deformation of the image through the control points. In the embodiment of this application, TPS interpolation can simulate the rapid shaking of the camera.

In some embodiments, the image semantic segmentation model is obtained by training based on a basic sample library and an enhanced sample library.

The basic sample library includes a semantic segmentation label of a previous sample video frame, a current sample video frame, and a semantic segmentation label of the current sample video frame.

The enhanced sample library includes a semantic segmentation label of a previous sample video frame, a current enhanced video frame, and a semantic segmentation label of the current enhanced video frame.

The current enhanced video frame is obtained by performing affine transformation or thin plate spline interpolation on the current sample video frame. The semantic segmentation label of the current enhanced video frame is obtained by performing affine transformation and/or thin plate spline interpolation on the semantic segmentation label of the current sample video frame.

In the case of limited samples in the basic sample library, in order to simulate scenes such as the movement of real characters or the rapid shaking of the camera, the same pair of “current sample video frame+semantic segmentation label” is subjected to the same affine transformation or thin plate spline interpolation, and a new pair of “current enhanced video frame+semantic segmentation label” is obtained, thus forming an enhanced sample. After several different affine transformation or thin plate spline interpolation, a plurality of enhanced samples can be obtained, thus forming an enhanced sample library.

Optionally, the server performs the same affine transformation or thin plate spline interpolation on the background region in the same pair of the current sample video frame and the semantic segmentation label of the current sample video frame to obtain a first enhanced sample. The server performs the same affine transformation or thin plate spline interpolation on the foreground character region in the same pair of the current sample video frame and the semantic segmentation label of the current sample video frame to obtain a second enhanced sample.

In the embodiment based on FIG. 11, the image semantic segmentation model may be implemented using a Fully Convolutional Network (FCN).

The image semantic segmentation model needs to determine the category of each pixel in the image. That is, image semantic segmentation is performed at a pixel level. In the past, Convolutional Neural Network (CNN) was used for semantic segmentation, where each pixel was labeled with a region category surrounding itself. However, this method has significant drawbacks in terms of speed and accuracy. FCN is obtained through improvement based on CNN.

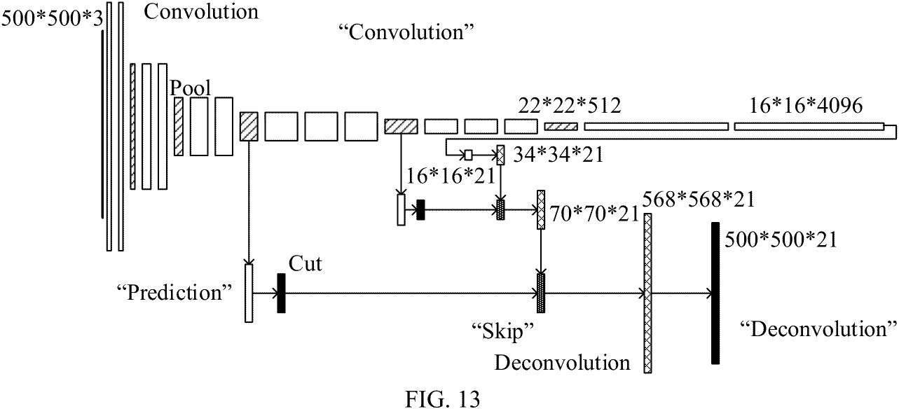

Referring to FIG. 13, the overall network structure of the FCN is divided into two parts, including a fully convolutional part and a deconvolutional part. The fully convolutional part borrows some classic CNNs (such as AlexNet which is a neural network launched in 2012, Visual Geometry Group (VGG) network and GoogLeNet which is a new deep learning structure proposed in 2014), and replaces a final fully-connected layer with a convolutional layer which is used for extracting features to form a heat map. The deconvolutional part performs up-sampling on the small-sized heat map to obtain a semantic segmentation image of the original size. The input of the FCN may be a color image of any size. The output size and the input size are the same. The number of channels is n (number of target categories)+1 (background). The purpose of not using the fully-connected layer at the convolutional part of the CNN in the FCN but replacing with a convolutional layer is to allow the input image to be of any size exceeding a certain size.

Since the heat map becomes very small in the convolution process (such as the length and width becoming 7/50 of the original image), up-sampling is necessary to obtain the dense pixel prediction of the original image size. An intuitive idea is to perform bilinear interpolation. Bilinear interpolation can be easily achieved by reverse convolution through a fixed convolution kernel. Reverse convolution, also known as deconvolution, is often referred to as transposed convolution.

If the up-sampling described above is used for up-sampling the feature map of the last layer to obtain the segmentation of the original image size, since the size of the feature map of the last layer is too small, a lot of details will be lost. Therefore, it is proposed to add skips structure to combine the prediction of the last layer (with richer global information) and the prediction of the shallower layer (with more local details), so that local prediction can be achieved while adhering to global prediction.

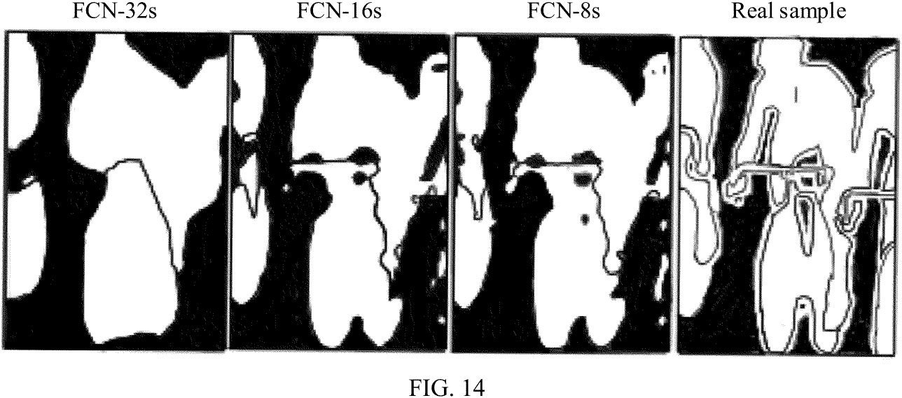

A prediction (FCN-32s) of a bottom layer (step size: 32) is up-sampled twice to obtain an image of the original size, and is fused (added) with a prediction from pool 4 layer (step size: 16). This part of network is called FCN-16s. Subsequently, this part of prediction is up-sampled twice and fused with a prediction obtained from pool 3 layer. This part of network is called FCN-8s. Referring to FIG. 14, it illustrates comparison of effects between FCN-32s, FCN-16s and FCN-8s, and a real sample. It can be seen that the semantic segmentation result of FCN-8s is closest to the real sample, the semantic segmentation result of FCN-8s is better than that of FCN-16s, and the semantic segmentation result of FCN-16s is better than that of FCN-32s.

The FCN classifies images at the pixel level, thus solving the problem of semantic-level image segmentation. Unlike the classical CNN which uses a fully-connected layer to obtain a fixed-length feature vector for classification after the convolutional layer, the FCN can accept input images of any size and up-sample the feature map of the last convolutional layer using the deconvolutional layer to restore to the same size as the input image, thus generating a prediction for each pixel while preserving the space information in the original input image, and finally, perform pixel-by-pixel classification on the up-sampled feature map. Finally, the classification loss is calculated pixel by pixel, equivalent to each pixel corresponding to a training sample.

Simply speaking, the difference of the FCN from the CNN is that the output is a labeled image by replacing the fully-connected layer at the end of the CNN with a convolutional layer.

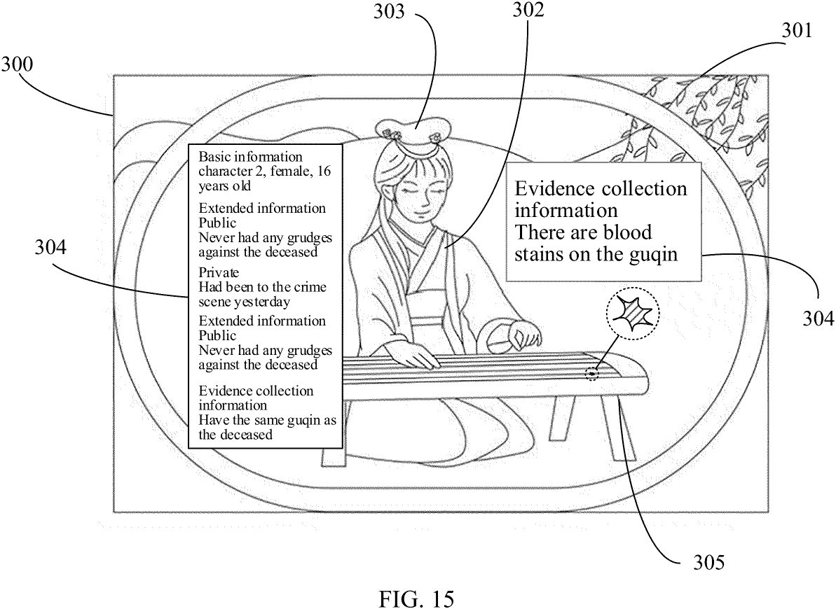

FIG. 15 illustrates an AR picture 300 displayed by the AR terminal of user E during the evidence collection phase, which includes an AR background region 301, an AR character region 302, and an AR information control. The AR background region 301 displays a virtual scene and a virtual prop 305 during the evidence collection stage. The AR character region 302 displays a real character wearing an AR costume 303. The AR costume 303 corresponds to a virtual character in the story scene. The AR information control 304 displays the character information or evidence collection information about the virtual character, which may be located on the periphery of the real character bound to the virtual character or at the position where the evidence collection information is acquired.

Exemplarily, the AR background region 301 is displayed as a place under willow trees at the foot of a mountain outside the city. The AR character region 302 displays user B wearing an ancient AR costume, and user B is playing an AR virtual guqin. The character information about the second virtual character acquired by user E is displayed on the AR information control 304 on the periphery of the user B. The private information about the second virtual character acquired by user E cannot be viewed by user A, user B, user C, and user D. The public information about the second virtual character acquired by user E can be viewed by user A, user B, user C, and user D. The evidence collection information about the second virtual character acquired by user E after an evidence collection operation on the virtual guqin is displayed on the AR information control located at the position where the evidence collection information is acquired. The information may be selected to be public or private. If it is selected to be public, other virtual characters in the story scene can also view it. If it is selected to be private, other virtual characters in the story scene cannot view it.

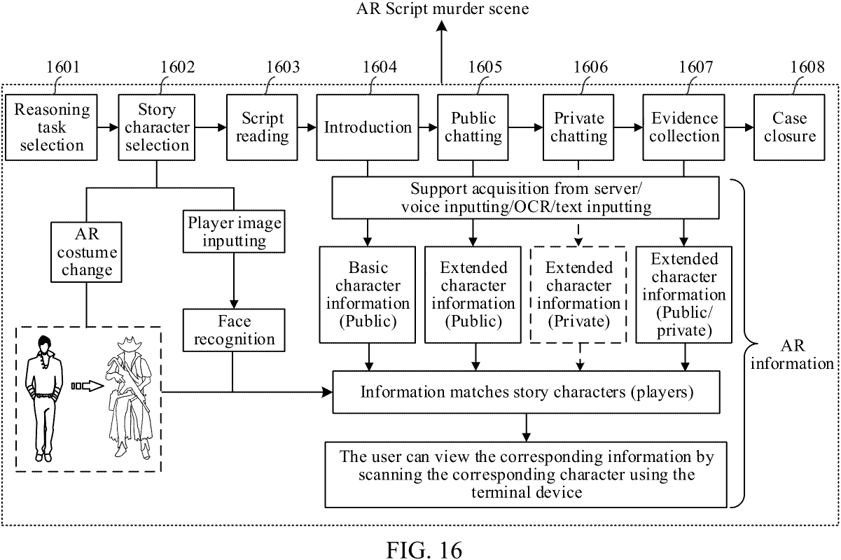

FIG. 16 illustrates a game scene flowchart of a method for human-machine interaction based on a story scene according to an exemplary embodiment of this application. This embodiment will be described by taking the method being executed by a terminal illustrated in FIG. 3 as an example. The terminal is provided with a camera. The method includes the following steps: reasoning task selection 1601, virtual character selection 1602, script reading 1603, introduction stage 1604, public chatting stage 1605, private chatting stage 1606, evidence collection stage 1607, and case closure stage 1608.

Reasoning task selection 1601: a user selects any one reasoning task from reasoning tasks of at least two candidate story scenes displayed on the terminal.

Exemplarily, user A selects a gunfight spy scene from gunfight spy scenes, fairy immortality cultivation scenes, western cowboy scenes and ancient tomb exploration scenes.

Story character selection 1602: after the user selects the story scene, the user selects any virtual character from at least two candidate virtual characters displayed on the terminal. The camera of the terminal collects a user image. Face recognition is performed. AR costume change is performed on the user to match the virtual characters with the user.

Exemplarily, user A selects a first virtual character agent A, completes character binding and completes AR costume change.

Script reading 1603: the user reads background information about the selected story scene, understands the background, time, task and basic information about the bound virtual character of the story scene.

Introduction stage 1604: the user introduces himself or herself to other virtual characters in the same story scene and acquires basic information about other virtual characters in the same story scene. The information is public information. A method for acquiring the information includes at least one of acquisition from a sever, voice inputting, OCR scanning, and keyboard inputting. The information is displayed in an AR information control. The user can view the AR information by scanning the corresponding virtual character using a terminal device.

Exemplarily, user A introduces himself or herself to other users in the same story scene and acquires basic information about user B and user C from the server. The basic information is displayed in the AR information control located on the periphery of user B and user C. The basic information is public information. User A, user B and user C can view the basic information by scanning the corresponding virtual character using the terminal device.

Public chatting stage 1605: all users in the same story scene exchange information and acquire extended information about virtual characters in the same story scene. The information is public information. A method for acquiring the information includes at least one of acquisition from a sever, voice inputting, OCR scanning, and keyboard inputting. The information is displayed in the AR information control. The user can view the AR information by scanning the corresponding virtual character using the terminal device.

Exemplarily, user A acquires past three days’ schedules of user B and user C through OCR scanning during the public chatting stage. The information is displayed in the AR information control located on the periphery of user B and user C. The information is public information. User A, user B and user C can view the extended information by scanning the virtual characters bound to user B and user C using the terminal device.

Private chatting stage 1606: only two users in the same story scene exchange information and acquire extended information about the virtual characters privately chatting with each other. The information is private information. A method for acquiring the information includes at least one of acquisition from a sever, voice inputting, OCR scanning, and keyboard inputting. The information is displayed in the AR information control. The user can view the AR information by scanning the corresponding virtual character using the terminal device.

Exemplarily, user A privately chats with user B and acquires the extended information about the second virtual character bound to user B through text inputting. The tool of user B comes from user C. The information is displayed in the AR information control located on the periphery of user B. Only user A has the viewing permission to view the information. User A can view the extended information by scanning the second virtual character bound by user B using the terminal device.

Evidence collection stage 1607: the virtual character performs an evidence collection operation on virtual scenes or props related to other virtual characters in the same story scene, and acquires evidence collection information about the other virtual characters. The information may be selected to be public or private. If it is selected to be public, other virtual characters in the story scene can also view it. If it is selected to be private, other virtual characters in the story scene cannot view it. The user can view the evidence collection information by scanning the corresponding virtual character or virtual prop using the terminal device.

Exemplarily, user A performs an evidence collection operation on a desk of the third virtual character bound to user C and acquires a tool purchase list. The information is displayed on the AR information control located at the position of the desk. User A selects to make the evidence collection information public. User A, user B and user C all can view the evidence collection information by scanning the third virtual character bound to user C or the desk using the terminal device.

Case closure stage 1608: user A, user B and user C vote, the voting result shows that user B is the target character, the reasoning result is correct, the reasoning task is completed, and the case is closed.

To sum up, in the method provided in this embodiment, since the human-machine interaction and reasoning tasks are performed by using the terminal, the users are bound to the virtual characters through face recognition and AR costume change, and the character information and evidence collection information are acquire through at least one of acquisition from the server, voice inputting, OCR scanning and keyboard inputting, the game is simple and convenient to operate, thus providing a more immersive game experience.

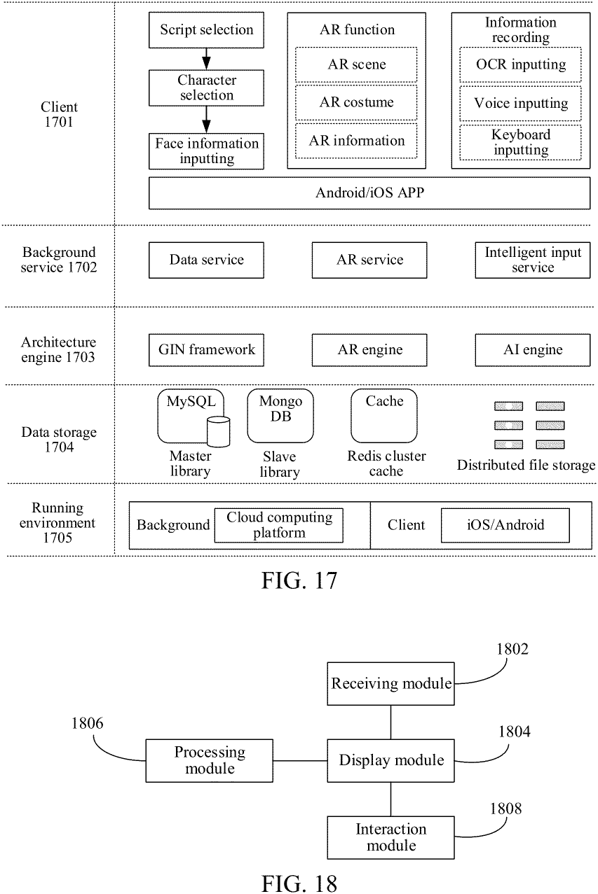

FIG. 17 illustrates a structural block diagram of a computer system according to another exemplary embodiment of this application. This embodiment will be described by taking the method being executed by the computer system illustrated in FIG. 3 as an example. The system includes client 1701, background service 1702, architecture engine 1703, data storage 1704, and running environment 1705.

Client 1701: it refers to Android or iOS application program that supports AR interaction and reasoning tasks on the terminal. The terminal may be an electronic device with a camera, such as smart phone, tablet, e-book reader, laptop, desktop computer, or AR glasses. The client 1701 supports the terminal to perform script selection operations, virtual character selection operations, and face information inputting. The client 1701 supports AR function of displaying at least one of AR scenes, AR costumes and AR information. The client 1701 supports information recording function, which can record information through at least one of OCR inputting, voice inputting, and keyboard inputting.

Background service 1702: it refers to at least one of background services provided by the server 320, including data service, AR service and intelligent inputting service that support the execution of the client 1701, such as intercepting and responding to requests from the client 1701, screening and filtering all requests from the client 1701 or calling third-party interfaces, wrapping information, and then returning it to the client 1701.

Architecture engine 1703: it performs operations such as application program startup, processing of request parameters, and rendering of response formats through the GIN framework (a web page framework), operations such as processing of AR functions through the AR engine, and computing operations related to machine learning through the AI engine.

Data storage 1704: it includes an MySQL database (a relational database management system) that stores general information and an MongoDB database (a distributed file storage based database) that stores massive user logs and user graphs. Both databases perform storage independently, realize cluster distributed deployment and storage through Hadoop (a distributed system infrastructure), and utilize Distributed Relational Database Service (DRDS) as middleware to realize elastic storage.

Running environment 1705: the background service 1702 utilizes a cloud computing platform to undertake the training tasks of the discriminator and the generator based on client datasets. Through face recognition and image semantic recognition, the real video stream is replaced with an AR video stream, and then the image is transmitted back to the Android or iOS client 1701 that supports AR interaction and reasoning tasks, thus providing users with a smoother and more immersive AR experience.

A person of skill in the art can understand that, the computer structure illustrated in FIG. 17 does not constitute a limitation on the computer system, which may include components that are more or fewer than those illustrated therein, or a combination of some components, or different component arrangements,

FIG. 18 illustrates a block diagram of an apparatus for human-machine interaction based on a story scene according to an exemplary embodiment of this application. The apparatus includes an acquisition module 1802, a display module 1804, a processing module 1806 and an interaction module 1808.

The acquisition module 1802 is configured to execute step S220 illustrated in FIG. 2 in the embodiment above.

The display module 1804 is configured to execute step S240 illustrated in FIG. 2 in the embodiment above.

The display module 1804 is configured to display first AR information in the AR video stream. The first AR information is used for displaying the character information about the first virtual character. The display module 1804 is configured to display second AR information in the AR video stream. The second AR information is used for displaying the evidence collection information about the first virtual character.

In an exemplary embodiment, the display module 1804 is configured to display a first AR information control located on the periphery of the real character in the AR video stream. The first AR information control displays the first AR information. The display module 1804 is configured to display second AR information control in the AR video stream. The second AR information control is configured to display the second AR information.

In an exemplary embodiment, the display module 1804 is configured to display a second face picture of the real character not wearing the AR device in a second face region of the AR character region.

The processing module 1806 is configured to execute at least one of step S241 to step 247 illustrated in FIG. 2 in the embodiment above.

The interaction module 1808 is configured to execute at least one of step 260 illustrated in FIG. 2, step 266a to step 268a illustrated in FIG. 8, step 266c to step 268b illustrated in FIG. 9, and step 266e to step 268c illustrated in FIG. 10 in the embodiments above.

In an exemplary embodiment, the interaction module 1808 is configured to: acquire the character information about the first virtual character from a server; acquire the character information about the first virtual character through voice inputting; acquire the character information about the first virtual character through optical character recognition OCR scanning; or acquire the character information about the first virtual character through keyboard inputting.

In an exemplary embodiment, the apparatus further includes an uploading module configured to receive an uploading operation on an AR costume; and upload the AR costume created locally to the server in response to the uploading operation.

In an exemplary embodiment, the apparatus further includes a self-defining module configured to receive a self-defining operation on an AR costume; and upload the AR costume self-defined to the server in response to the self-defining operation.

It is to be understood that this embodiment only provides a brief description of the functions of the modules, and a reference may be made to the content in the embodiment for details.

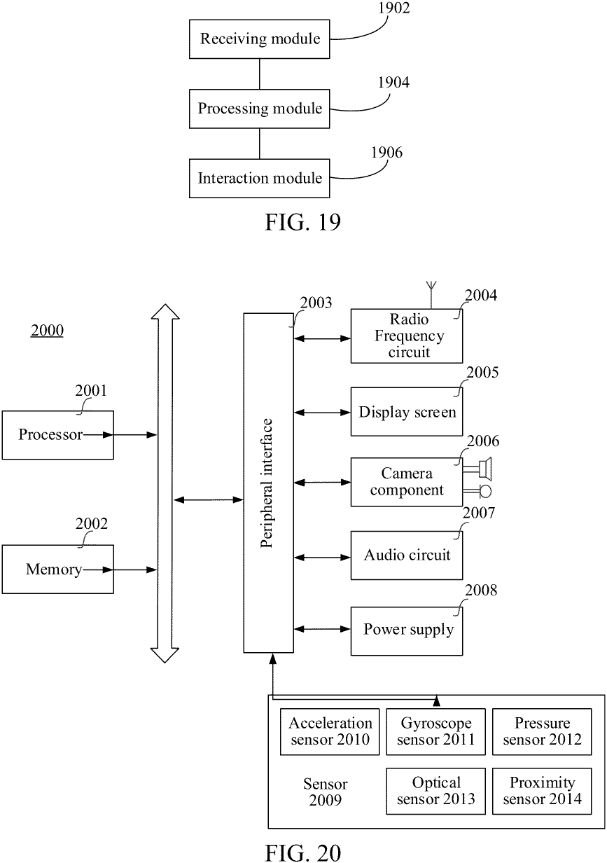

FIG. 19 illustrates a block diagram of an apparatus for human-machine interaction based on a story scene according to an exemplary embodiment of this application. The apparatus includes a receiving module 1902, a processing module 1904 and an interaction module 1906.

The receiving module 1902 is configured to execute step 1103 illustrated in FIG. 11 in the embodiment above.

The processing module 1904 is configured to execute at least one of step 1104 to step 1106 illustrated in FIG. 11 in the embodiment above.

The interaction module 1906 is configured to complete a reasoning task corresponding to the story scene based on the AR video stream.

The interaction module 1906 is configured to complete at least one of an information acquisition task, an evidence collection task and a puzzle reasoning task corresponding to the story scene based on the AR video stream obtained after processing by the processing module 1904.

In an exemplary embodiment, the interaction module 1906 is configured to acquire character information about the first virtual character. In an exemplary embodiment, the interaction module 1906 is configured to evidence collection information about the first virtual character.

In an exemplary embodiment, the interaction module 1906 is configured to perform evidence collection on the reasoning task corresponding to the story scene in a time dimension in response to a reasoning operation on the time line control. Alternatively, the interaction module 1906 is configured to perform evidence collection on the reasoning task corresponding to the story scene in a space dimension in response to a reasoning operation on the virtual map control. Alternatively, the interaction module 1906 is configured to acquire first evidence collection information about the first virtual character in the virtual scene in response to a viewing operation on a designated position in the virtual scene. Alternatively, the interaction module 1906 is configured to acquire second evidence collection information about the first virtual character associated with the virtual prop in response to an interaction operation on the virtual prop. Alternatively, the interaction module 1906 is configured to acquire third evidence collection information about the first virtual character in response to an interaction operation on the NPC virtual character.

It is to be understood that this embodiment only provides a brief description of the functions of the modules, and a reference may be made to the content in the embodiment for details.

It is to be understood that when the apparatus provided in the embodiment implements human-machine interaction based on a story scene, only division of the function modules is used as an example for description; in the practical application, the functions may be allocated to and completed by different function modules according to requirements, that is, an internal structure of the device is divided into different function modules, to complete all or some of the functions described above. In addition, for details of a specific implementation process, refer to the method embodiments, which are not repeated here.

FIG. 20 illustrates a structural block diagram of a terminal 2000 according to an exemplary embodiment of this application. The terminal 2000 may be an electronic device with a camera, such as smart phone, tablet, e-book reader, laptop, desktop computer, or AR glasses. The terminal 2000 may also be referred to as another name such as user equipment, a portable terminal, a laptop terminal, or a desktop terminal.

Generally, the terminal 2000 includes a processor 2001 and a memory 2002.

The processor 2001 may include one or more processing cores. For example, it is a 4-core processor or 8-core processor. The processor 2001 may be implemented in at least one hardware form of a digital signal processor (DSP), a field-programmable gate array (FPGA), and a programmable logic array (PLA). The processor 2001 may also include a main processor and a coprocessor. The main processor is a processor configured to process data in an awake state, and is also referred to as a Central Processing Unit (CPU). The coprocessor is a low power consumption processor configured to process data in a standby state. In some embodiments, the processor 2001 may be integrated with a Graphics Processing Unit (GPU). The GPU is configured to render and draw the content that needs to be displayed on a display screen. In some embodiments, the processor 2001 may further include an augmented reality (AR) processor. The AR processor is configured to process computing operations related to augmented reality. In some embodiments, the processor 2001 may further include an Artificial Intelligence (AI) processor. The AI processor is configured to process computing operations related to machine learning.

The memory 2002 may include one or more computer-readable storage media. The computer-readable storage medium may be non-transient. The memory 2002 may further include a high-speed random access memory and a nonvolatile memory, for example, one or more disk storage devices or flash storage devices. In some embodiments, the non-transitory computer-readable storage medium in the memory 2002 is configured to store at least one instruction, and the at least one instruction is executed by the processor 2001 to implement the method for human-machine interaction based on the story scene provided in the method embodiments of this application.

In some embodiments, the terminal 2000 may further includes a peripheral interface 2003 and at least one peripheral. The processor 2001, the memory 2002, and the peripheral interface 2003 may be connected through a bus or a signal cable. Each peripheral may be connected to the peripheral interface 2003 through a bus, a signal cable, or a circuit board. Specifically, the peripheral may include at least one of a Radio Frequency (RF) circuit 2004, a display screen 2005, a camera component 2006, an audio circuit 2007, and a power supply 2008.

The peripheral interface 2003 may be configured to connect the at least one peripheral related to Input/Output (I/O) to the processor 2001 and the memory 2002.

The RF circuit 2004 is configured to receive and transmit an RF signal, also referred to as an electromagnetic signal.

The display screen 2005 is configured to display a user interface (UI).

The camera component 2006 is configured to capture images or videos.

The audio circuit 2007 may include a microphone and a speaker.

The power supply 2008 is configured to supply power to components in the terminal 2000.

In some embodiments, the terminal 2000 further includes one or more sensors 2009. The one or more sensors 2009 include, but not limited to, an acceleration sensor 2010, a gyroscope sensor 2011, a pressure sensor 2012, an optical sensor 2013, and a proximity sensor 2014.

The acceleration sensor 2010 may detect a magnitude of acceleration on three coordinate axes of a coordinate system established with the terminal 2000.

The gyroscope sensor 2011 may detect a body direction and a rotation angle of the terminal 2000. The gyroscope sensor 2011 may cooperate with the acceleration sensor 2011 to acquire a 3D action by the user on the terminal 2000.

The pressure sensor 2012 may be disposed at a side frame of the terminal 2000 and/or a lower layer of the display screen 2005.

The optical sensor 2013 is configured to acquire ambient light intensity.

The proximity sensor 2014, also referred to as a distance sensor, is generally disposed on the front panel of the terminal 2000. The proximity sensor 2014 is configured to acquire a distance between the user and the front surface of the terminal 2000. The memory further includes one or more programs. The one or more programs are stored in the memory. The one or more programs include a program for performing the method for displaying the signal based on the virtual environment provided in the embodiments of this application.

A person skilled in the art may understand that the structure illustrated in FIG. 20 constitutes no limitation on the terminal 2000, and the terminal may include more or fewer components than those illustrated therein, or some components may be combined, or a different component deployment may be adopted.

In an exemplarily embodiment, a terminal is further provided. The terminal includes a processor and a memory. At least one instruction, at least one section of program, a code set or an instruction set is stored in the memory. The at least one instruction, the at least one program, the code set, or the instruction set are configured to be executed by the processor, to implement the method for human-machine interaction based on the story scene.

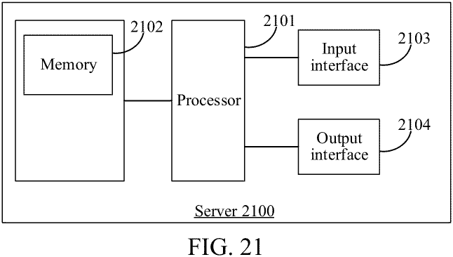

In an exemplary embodiment, a server 2100 is further provided. The server 2100 includes a processor 2101 and a memory 2102. FIG. 21 illustrates a structural block diagram of a server 2100 according to an exemplary embodiment of this application.

Generally, the server 2100 includes a processor 2101 and a memory 2102.

The processor 2101 may include one or more processing cores, for example, a 4-core processor or an 8-core processor. The processor 2101 may be implemented in at least one hardware form of a Digital Signal Processor (DSP), a Field-Programmable Gate Array (FPGA), and a Programmable Logic Array (PLA). The processor 2101 may also include a main processor and a coprocessor. The main processor is a processor configured to process data in an awake state, and is also referred to as a Central Processing Unit (CPU). The coprocessor is a low power consumption processor configured to process data in a standby state. In some embodiments, the processor 2101 may be integrated with a Graphics Processing Unit (GPU). The GPU is configured to render and draw content that needs to be displayed on a display screen. In some embodiments, the processor 2101 may further include an Artificial Intelligence (AI) processor. The AI processor is configured to process computing operations related to machine learning.

The memory 2102 may include one or more computer-readable storage media. The computer-readable storage medium may be non-transient. The memory 2102 may further include a high-speed random access memory and a nonvolatile memory, for example, one or more disk storage devices or flash storage devices. In some embodiments, the non-transitory computer-readable storage medium in the memory 2102 is configured to store at least one instruction, and the at least one instruction is executed by the processor 2101 to implement the method for computing the global illumination of the three-dimensional space provided in the method embodiments of this application.

In some embodiments, the server 2100 may further include an input interface 2103 and an output interface 2104. The processor 2101, the memory 2102, the input interface 2103 and the output interface 2104 may be connected through a bus or a signal cable. Each peripheral may be connected to the input interface 2103 and the output interface 2104 through a bus, a signal cable, or a circuit board. The input interface 2103 and the output interface 2104 may be configured to connect the at least one peripheral related to Input/Output (I/O) to the processor 2101 and the memory 2102. In some embodiments, the processor 2101, the memory 2102, the input interface 2103, and the output interface 2104 are integrated on the same chip or circuit board. In some embodiments, any one or two of the processor 2101, the memory 2102, the input interface 2103 and the output interface 2104 may be implemented on a single chip or circuit board, which is not limited in the embodiment of this application.

A person skilled in the art may understand that the structure illustrated therein constitutes no limitation on the server 2100, and the server may include more or fewer components than those illustrated therein, or some components may be combined, or a different component deployment may be used.

In an exemplary embodiment, a computer-readable storage medium is further provided. At least one instruction, at least one program, a code set or an instruction set is stored in the storage medium. The at least one instruction, the at least one program, the code set or the instruction set is executed by the processor of the terminal to implement the method for switching the view angle in the virtual environment. Optionally, the computer-readable storage medium may be a Read-Only Memory (ROM), a Random Access Memory (RAM), a Compact Disc Read-Only Memory (CD-ROM), a magnetic tape, a floppy disk, an optical data storage device, or the like.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. In an exemplary embodiment, a computer program product is further provided. The computer program product stores a computer program. The computer program is loaded and executed by a processor to implement the method for human-machine interaction based on the story scene described above.

What is claimed is:

1. A method for human-machine interaction based on a story scene performed by a terminal, the method comprising:
acquiring a real video stream of a physical environment, the real video stream comprising a background region and a foreground character region of the physical environment, the foreground character region including an actual human character;
displaying an augmented reality (AR) video stream of a virtual environment based on the real video stream, the AR video stream comprising an AR background region and an AR character region of the virtual environment, the AR background region displaying a scene picture of the story scene based on the background region, the AR character region displaying the human character wearing an AR costume corresponding to a virtual character in the story scene based on the foreground character region;
changing a display content of the AR video stream in response to an interaction operation performed by the actual human character; and
completing a reasoning task corresponding to the story scene based on the changed display content.

2. The method according to claim 1, wherein a first face region of the foreground character region displays a first face picture of the human character wearing an AR terminal; the method further comprises:
displaying a second face picture of the human character not wearing the AR terminal in a second face region of the AR character region.

3. The method according to claim 1, wherein the completing a reasoning task corresponding to the story scene based on the changed display content comprises:
completing an interactive reasoning task corresponding to the story scene based on the changed display content, the interactive reasoning task being a task of interacting with the scene picture of the story scene, and/or the interactive reasoning task being a task of interacting with the virtual character in the story scene.

4. The method according to claim 1, wherein the changing a display content of the AR video stream in response to an interaction operation performed by the human character comprises at least one of:
changing a display content of the AR background region in response to an item interaction operation with a virtual item performed by the actual human character in the AR background region;
changing character information about the human character in response to a character interaction operation with the human character in the AR character region;
changing the scene picture of the story scene in response to a scene switching operation on the story scene; and
changing a display content related to a story plot in the AR video stream in response to a story plot trigger operation on the story scene.

5. The method according to claim 1, wherein the method further comprises:
displaying a task selection control for at least two candidate story scenes; and
determining a selected story scene of the at least two candidate story scenes in response to a selection operation on the task selection control.

6. The method according to claim 1, wherein the method further comprises:
displaying a character selection control for at least two candidate virtual characters in the story scene;
determining a selected virtual character of the at least two candidate virtual characters in response to a selection operation on the character selection control; and
binding the selected virtual character to face data of the real character corresponding to the terminal.

7. The method according to claim 1, wherein the method further comprises:
receiving an uploading operation on the AR costume; and
uploading the AR costume created locally to a server in response to the uploading operation.

8. The method according to claim 1, wherein the method further comprises:
receiving a self-defining operation on the AR costume; and
uploading the AR costume self-defined to a server in response to the self-defining operation.

9. A terminal, comprising: a processor and a memory, the memory storing a computer program, the computer program being loaded and executed by the processor and causing the terminal to implement a method for human-machine interaction based on a story scene, the method comprising:
acquiring a real video stream of a physical environment, the real video stream comprising a background region and a foreground character region of the physical environment, the foreground character region including an actual human character;
displaying an augmented reality (AR) video stream of a virtual environment based on the real video stream, the AR video stream comprising an AR background region and an AR character region of the virtual environment, the AR background region displaying a scene picture of the story scene based on the background region, the AR character region displaying the human character wearing an AR costume corresponding to a virtual character in the story scene based on the foreground character region;
changing a display content of the AR video stream in response to an interaction operation performed by the actual human character; and
completing a reasoning task corresponding to the story scene based on the changed display content.

10. The terminal according to claim 9, wherein a first face region of the foreground character region displays a first face picture of the human character wearing an AR terminal; the method further comprises:
displaying a second face picture of the human character not wearing the AR terminal in a second face region of the AR character region.

11. The terminal according to claim 9, wherein the completing a reasoning task corresponding to the story scene based on the changed display content comprises:
completing an interactive reasoning task corresponding to the story scene based on the changed display content, the interactive reasoning task being a task of interacting with the scene picture of the story scene, and/or the interactive reasoning task being a task of interacting with the virtual character in the story scene.

12. The terminal according to claim 9, wherein the changing a display content of the AR video stream in response to an interaction operation performed by the human character comprises at least one of:
changing a display content of the AR background region in response to an item interaction operation with a virtual item performed by the actual human character in the AR background region;
changing character information about the human character in response to a character interaction operation with the human character in the AR character region;
changing the scene picture of the story scene in response to a scene switching operation on the story scene; and
changing a display content related to a story plot in the AR video stream in response to a story plot trigger operation on the story scene.

13. The terminal according to claim 9, wherein the method further comprises:
displaying a task selection control for at least two candidate story scenes; and
determining a selected story scene of the at least two candidate story scenes in response to a selection operation on the task selection control.

14. The method according to claim 1, wherein the method further comprises:
displaying a character selection control for at least two candidate virtual characters in the story scene;
determining a selected virtual character of the at least two candidate virtual characters in response to a selection operation on the character selection control; and
binding the selected virtual character to face data of the real character corresponding to the terminal.

15. The terminal according to claim 9, wherein the method further comprises:
receiving an uploading operation on the AR costume; and
uploading the AR costume created locally to a server in response to the uploading operation.

16. The terminal according to claim 9, wherein the method further comprises:
receiving a self-defining operation on the AR costume; and
uploading the AR costume self-defined to a server in response to the self-defining operation.

17. A non-transitory computer-readable storage medium, storing a computer program, the computer program being loaded and executed by a processor of a terminal and causing the terminal to implement a method for human-machine interaction based on the story scene according to any one of claims 1 to 26 or the method for human-machine interaction based on the story scene, the method comprising:
acquiring a real video stream of a physical environment, the real video stream comprising a background region and a foreground character region of the physical environment, the foreground character region including an actual human character;
displaying an augmented reality (AR) video stream of a virtual environment based on the real video stream, the AR video stream comprising an AR background region and an AR character region of the virtual environment, the AR background region displaying a scene picture of the story scene based on the background region, the AR character region displaying the human character wearing an AR costume corresponding to a virtual character in the story scene based on the foreground character region;
changing a display content of the AR video stream in response to an interaction operation performed by the actual human character; and
completing a reasoning task corresponding to the story scene based on the changed display content.

18. The non-transitory computer-readable storage medium according to claim 17, wherein a first face region of the foreground character region displays a first face picture of the human character wearing an AR terminal; the method further comprises:
displaying a second face picture of the human character not wearing the AR terminal in a second face region of the AR character region.

19. The non-transitory computer-readable storage medium according to claim 17, wherein the completing a reasoning task corresponding to the story scene based on the changed display content comprises:
completing an interactive reasoning task corresponding to the story scene based on the changed display content, the interactive reasoning task being a task of interacting with the scene picture of the story scene, and/or the interactive reasoning task being a task of interacting with the virtual character in the story scene.

20. The non-transitory computer-readable storage medium according to claim 17, wherein the changing a display content of the AR video stream in response to an interaction operation performed by the human character comprises at least one of:
changing a display content of the AR background region in response to an item interaction operation with a virtual item performed by the actual human character in the AR background region;
changing character information about the human character in response to a character interaction operation with the human character in the AR character region;
changing the scene picture of the story scene in response to a scene switching operation on the story scene; and
changing a display content related to a story plot in the AR video stream in response to a story plot trigger operation on the story scene.
